(19) United States
(12) Patent Application Publication
(10) Pub. No.: US 2024/0222735 A1
(43) Pub. Date: Jul. 4, 2024

(54) LITHIUM BATTERY

(71) Applicant: Samsung Electronics Co., Ltd., Suwon-si (KR)

(72) Inventors: Jusik Kim, Suwon-si (KR); Jirae Kim, Suwon-si (KR); Junhyeong Lee, Suwon-si (KR)

(21) Appl. No.: 18/339,448

(22) Filed: Jun. 22, 2023

(30) Foreign Application Priority Data
Jan. 3, 2023 (KR) 10-2023-0000921

(51) Int. Cl. H01M 10/615; H01M 4/66; H05B 3/14; H05B 3/18

(52) U.S. Cl. CPC H01M 10/615; H01M 4/662; H05B 3/145; H05B 3/146; H05B 3/18; H01M 10/0525

(57) ABSTRACT

Provided is a lithium battery including a plurality of unit cells; and one or more current collecting members, wherein each of the plurality of unit cells includes a first electrode active material layer, a second electrode active material layer, and an electrolyte layer disposed between the first electrode active material layer and the second electrode active material layer, the one or more current collecting members includes a first current collecting member disposed between a first unit cell and a second unit cell adjacent to each other, the first current collecting member includes a first surface in contact with the first unit cell, a second surface facing the first surface and in contact with the second unit cell, a first current collector, and a heating element disposed between the first surface and the second surface, wherein the heating element is spaced apart from the first unit cell and the second unit cell.

### CROSS-REFERENCE TO RELATED APPLICATION

This application claims priority to and the benefit of Korean Patent Application No. 10-2023-0000921, filed on Jan. 3, 2023, in the Korean Intellectual Property Office, and all the benefits accruing therefrom under 35 U.S.C. § 119, the entire content of which is incorporated by reference herein.

### BACKGROUND

### 1. Field

The present subject matter relates to a lithium battery.

### 2. Description of the Related Art

In order to meet the trend towards more compact, high-performance devices, it is becoming attractive to manufacture lithium batteries that are smaller and lightweight, and that also have a high energy density. That is, a small lithium battery having a greater capacity is becoming desirable.

In general, the actual capacity of a high-capacity lithium battery may be reduced compared to the design capacity during high-speed charging and discharging cycles. That is, the high-rate characteristics of the lithium battery may deteriorate. To obtain an actual, working capacity that is close to the design capacity of the lithium battery, low-speed charging/discharging may be required. When the content of the conductive material in the electrode active material layer is increased, the high-rate characteristics of the lithium battery may be improved, but the content of the electrode active material in the electrode active material layer may be decreased, and thus, the capacity of the lithium battery may be reduced.

Therefore, there is a continuing need for a lithium battery that provides excellent high-rate characteristics while suppressing capacity degradation.

### SUMMARY

Provided is a lithium battery that has improved high-rate characteristics while suppressing capacity degradation based on the structure of the lithium battery.

Another aspect is to provide an electrode current collector which, by having a particular structure, can reduce the density of the electrode current collector, improving the energy density of a lithium battery, and suppressing an increase in the short-circuit current when the lithium battery is short-circuited.

Additional aspects will be set forth in part in the detailed description that follows and, in part, will be apparent from the detailed description, or may be learned by practice of the presented exemplary embodiments described herein.

According to an aspect, provided is a lithium battery including a plurality of unit cells, and one or more current collecting members, wherein each of the plurality of unit cells includes a first electrode active material layer, a second electrode active material layer, and an electrolyte layer disposed between the first electrode active material layer and the second electrode active material layer, the one or more current collecting members includes a first current collecting member disposed between a first unit cell and a second unit cell of the plurality of unit cells, wherein the first unit cell and the second unit cell are adjacent to each other, the first current collecting member includes a first surface in contact with the first unit cell, a second surface facing the first surface and in contact with the second unit cell, a first current collector, and a heating element disposed between the first surface and the second surface, and the heating element is spaced apart from the first unit cell and the second unit cell.

According to another aspect, provided is a current collecting member including a first current collecting layer including the first surface, a second current collecting layer including the second surface, and a heating layer disposed between the first current collecting layer and the second current collecting layer, wherein each of the first current collecting layer and the second current collecting layer includes a metal that does not form an alloy or compound with lithium, the heating layer includes a base film and a heating element, the base film includes a polymer, and the heating element is electrically separated from the first current collecting layer and the second current collecting layer.

### BRIEF DESCRIPTION OF THE DRAWINGS

The above and other aspects, features, and advantages of certain exemplary embodiments will be more apparent from the following detailed description taken in conjunction with the accompanying drawings, in which:

FIG. 1 is a schematic cross-sectional view of a bi-cell lithium battery including a mono-polar current collecting member according to one or more embodiments;

FIG. 2 is a schematic cross-sectional view of a bi-cell lithium battery including a mono-polar current collecting member according to one or more embodiments;

FIG. 3 is a schematic cross-sectional view of a bi-cell lithium battery including a mono-polar current collecting member according to one or more embodiments;

FIG. 4 is a perspective view of a current collecting member according to one or more embodiments;

FIG. 5 is a plan view of a current collecting member according to one or more embodiments;

FIG. 6 is a cross-sectional view of a current collecting member according to one or more embodiments;

FIG. 7 is an exploded view of a current collecting member according to one or more embodiments;

FIG. 8 is a cross-sectional view of a lithium battery according to one or more embodiments;

FIG. 9 is a cross-sectional view of a lithium battery according to one or more embodiments;

FIGS. 10A to 10S are each plan views of the arranged patterns of a heating element according to one or more embodiments;

FIG. 11 is a schematic diagram of a lithium battery according to one or more embodiments;

FIG. 12 is a schematic diagram of a lithium battery according to one or more embodiments;

FIG. 13 is a schematic diagram of a lithium battery according to one or more embodiments;

FIG. 14 is a Nyquist plot of imaginary impedance (Z″, ohm per square centimeter, ohm/cm²) versus real impedance (Z′, ohm/cm²) showing the impedance measurement results for lithium batteries of Example 1 and Comparative Example 1;

FIG. 15 is a graph of potential (Volts (V) versus Li/Li⁺) versus capacity (milliampere hours (mAh)) showing the charging profiles of lithium batteries of Example 1 and Comparative Example 1;

FIG. 16 is a graph of potential (V versus Li/Li⁺) versus capacity (mAh) showing a charge/discharge profile for each rate of the lithium battery of Example 1;

FIG. 17 is a graph of potential (V versus Li/Li⁺) versus capacity (mAh) showing a charge/discharge profile for each rate of the lithium battery of Comparative Example 1;

FIG. 18 is a graph of electrode potential (V versus Li/Li⁺) versus capacity (mAh) showing a charge/discharge profile for each rate of the lithium battery of Comparative Example 2; and

FIG. 19 is a graph of capacity (mAh) versus cycle number showing the discharge capacity of the lithium battery of Example 1 according to the number of charge/discharge cycles.

### DETAILED DESCRIPTION

Reference will now be made in further detail to exemplary embodiments, examples of which are illustrated in the accompanying drawings, wherein like reference numerals refer to like elements throughout. In this regard, the present exemplary embodiments may have different forms and should not be construed as being limited to the detailed descriptions set forth herein. Accordingly, the exemplary embodiments are merely described in further detail below, and by referring to the figures, to explain certain aspects and feature. As used herein, the term “and/or” includes any and all combinations of one or more of the associated listed items. Expressions such as “at least one of,” when preceding a list of elements, modify the entire list of elements and do not modify the individual elements of the list.

Hereinafter, as the disclosure allows for various changes and numerous embodiments, particular embodiments will be illustrated in the drawings and described in detail in the detailed description. However, this is not intended to limit the disclosure to particular modes of practice, and it is to be appreciated that all changes, equivalents, and substitutes that do not depart from the spirit and technical scope are encompassed in the disclosure.

The terminology used herein is for the purpose of describing one or more exemplary embodiments only and is not intended to be limiting. An expression used in the singular encompasses the expression of the plural, unless it has a clearly different meaning in the context. As used herein, it is to be understood that the terms such as “includes,” “have,” and “comprise” are intended to indicate the presence of the features, numbers, steps, actions, components, parts, ingredients, materials, or combinations thereof disclosed in the specification, but do not preclude the possibility that one or more other features, numbers, steps, actions, components, parts, ingredients, materials, or combinations thereof may exist or may be added. The symbol “/” used herein may be interpreted as “and” or “or” according to the context.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. In the drawings, the diameters, lengths, and thicknesses of layers and regions may be exaggerated or reduced for clarity.

Throughout the specification, like reference numerals refer to like elements. Throughout the specification, it is to be understood that when a component, such as a layer, a film, a region, or a plate, is referred to as being “on” another component, the component can be directly on the other component or intervening components may be present thereon. In contrast, when an element is referred to as being “directly on” another element, there are no intervening elements present.

Throughout the specification, the terms “first,” “second,” etc. may be used to describe various elements, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

As used herein, and unless otherwise defined, a “metal” includes both metals and metalloids such as silicon, germanium, or the like in an elemental or ionic state.

As used herein, an “alloy” refers to a mixture or combination of two or more metals.

As used herein, a “cathode active material” refers to a cathode material that may undergo lithiation and delithiation.

As used herein, an “anode active material” refers to an anode material that may undergo lithiation and delithiation.

As used herein, “lithiation” and “lithiating” refer to a process of adding lithium to a cathode active material or an anode active material.

As used herein, “delithiation” and “delithiating” refer to a process of removing lithium from a cathode active material or an anode active material.

As used herein, “charge” and “charging” refer to a process of providing electrochemical energy to a battery.

As used herein, “discharge” and “discharging” refer to a process of removing electrochemical energy from a battery.

As used herein, “positive electrode” and “cathode” refer to an electrode in which electrochemical reduction and lithiation occur during a discharging process.

As used herein, “negative electrode” and “anode” refer to an electrode in which electrochemical oxidation and delithiation occur during a discharging process.

As used herein, the “particle diameter” of a particle indicates an average diameter when the particle is spherical, and indicates an average major axis length when the particle is non-spherical. The diameter (or size) of the particles may be measured utilizing a scanning electron microscope or a particle size analyzer. As the particle size analyzer, for example, HORIBA, LA-950 laser particle size analyzer, may be utilized. The “particle size” of particles is, for example, an average particle size. Unless explicitly stated otherwise, the average particle diameter is a median particle diameter (D50). The median particle diameter (D50) is the particle size corresponding to the cumulative value of 50% from the smallest particle size in a particle size cumulative distribution curve in which particles accumulate in order of particle size from smallest particles to largest particles. The cumulative value may be, for example, a cumulative volume. The median particle diameter (D50) may be measured, for example, by a laser diffraction method.

As used herein, a “layer” includes not only a shape formed on the whole surface when viewed from a plan view, but also a shape formed on a partial surface.

As used herein, a “C rate” refers to a current which will discharge a battery in one hour, e.g., a C rate for a battery having a discharge capacity of 1.6 ampere-hours would be 1.6 amperes.

Hereinafter, a lithium battery according to exemplary embodiments will be described in further detail.

### Lithium Battery

A lithium battery according to an aspect includes a plurality of unit cells and one or more current collecting members, wherein each of the plurality of unit cells include a first electrode active material layer, a second electrode active material layer, and an electrolyte layer disposed between the first electrode active material layer and the second electrode active material layer, the one or more current collecting members include a first current collecting member disposed between a first unit cell and a second unit cell of the plurality of unit cells, wherein the first unit cell and the second unit cell are adjacent to each other, the first current collecting member includes a first surface in contact with the first unit cell, a second surface facing the first surface and in contact with the second unit cell, a first current collector, and a heating element disposed between the first surface and the second surface, and the heating element is spaced apart from the first unit cell and the second unit cell.

By including the heating element in the current collecting member, the kinetics of the electrochemical reaction in the lithium battery including the current collecting member may be improved. By including the heating element in the current collecting member, the rate of diffusion of lithium ions and/or electrons within a cathode and/or anode may be increased in the lithium battery including the current collecting member. By including the heating element in the current collecting member, the catholyte diffusion limit and/or anolyte diffusion limit may be improved in the lithium battery including the current collecting member. By including the heating element in the current collecting member, the internal resistance of the lithium battery including the current collecting member may be reduced. In addition, by including the heating element in the current collecting member, the energy density of the lithium battery including the current collecting member may be improved. As a result, by including the heating element in the current collecting member, the high-rate characteristics of the lithium battery including the current collecting member may be improved. As the lithium battery has improved high-rate characteristics, a decrease in the discharge capacity of the lithium battery may be suppressed, thereby enabling high-rate charging or high-speed charging of lithium batteries. However, in a lithium battery having a current collecting member that does not include a heating element (e.g., wherein none of the current collecting members include a heating element), the capacity of the lithium battery may significantly decrease during high-rate charging or high-speed discharging.

Since the heating element is spaced apart from the first unit cell and the second unit cell and disposed within the current collecting member, local temperature changes or variations on the surfaces of the first unit cell and the second unit cell may be suppressed. Since the heating element is spaced apart from the first unit cell and/or the second unit cell, the current collecting member may provide uniform heat energy to the first unit cell and/or the second unit cell. As a result, local temperature changes on the surfaces of the first unit cell and/or the second unit cell may be suppressed. However, in a lithium battery in which the heating element is in direct contact with the first unit cell and/or the second unit cell, due to a local temperature increase on the surfaces of the first unit cell and/or the second unit cell, deterioration such as melting of an electrode active material, for example, melting of lithium metal, and/or melting of a binder, may occur.

A lithium battery according to one or more embodiments will be described in further detail with reference to the drawings.

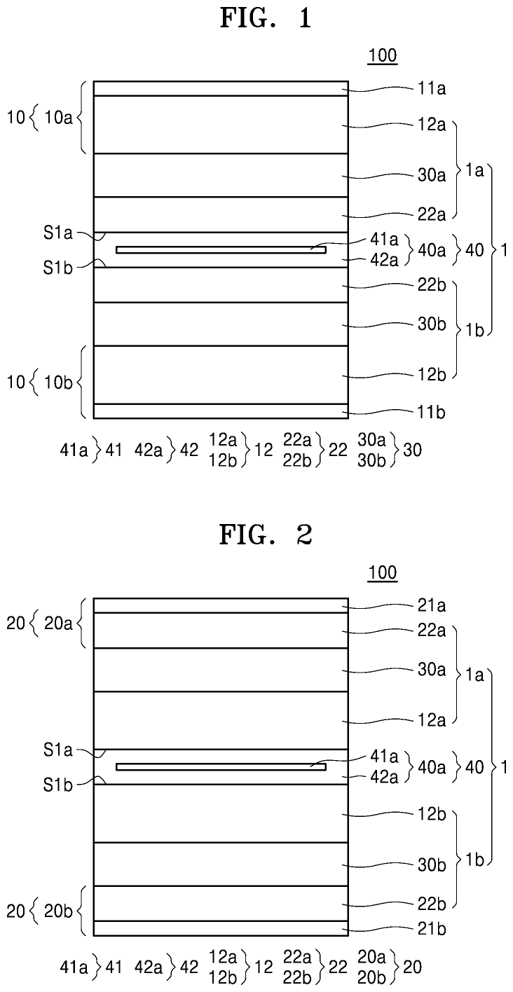

Referring to FIGS. 1 to 9, the lithium battery 100 includes a plurality of unit cells 1a and 1b, and one or more current collecting members 40a. As used herein, for convenience, the plurality of unit cells may be referred to collectively as 1, where a first unit cell is 1a and a second unit cell is 1b. For the sake of convenience, the plurality of unit cells may refer to either 1 or to both 1a and 1b. As used herein, for convenience, the first electrode active material layers may be referred to collectively as 12, where a first unit cell 1a includes the first electrode active material layer 12a and a second unit cell 1b includes the first electrode active material layer 12b. As used herein, for convenience, the second electrode active material layers may be referred to collectively as 22, where a first unit cell 1a includes the second electrode active material layer 22a and a second unit cell 1b includes the second electrode active material layer 22b. As used herein, for convenience, the electrolyte layers may be referred to collectively as 30, where a first unit cell 1a includes an electrolyte layer 30a and a second unit cell 1b includes an electrolyte layer 30b. As used herein, for convenience, the one or more current collecting members may be referred to collectively as 40, where a first current collecting member 40a is provided between the first unit cell 1a and the second unit cell 1b.

The plurality of unit cells 1a and 1b include first electrode active material layers 12a and 12b, second electrode active material layers 22a and 22b, and electrolyte layers 30a and 30b, in which the plurality of unit cells 1a and 1b are disposed between the first electrode active material layers 12a, and 12b, and the second electrode active material layers 22a and 22b, respectively. The one or more current collecting members 40 include a first current collecting member 40a disposed between the first unit cell 1a and the second unit cell 1b, which are adjacent to each other. The first current collecting member 40a includes a first surface S1a that is in contact with the first unit cell 1a, a second surface S1b opposite to the first surface and that is in contact with the second unit cell 1b, a first current collector 42a, and a heating element 41a that is disposed between the first surface S1a and the second surface S1b.

The heating element 41a is spaced apart from the first unit cell 1a and the second unit cell 1b. In other words, the heating element 41a is not disposed on the first surface S1a or the second surface S1b.

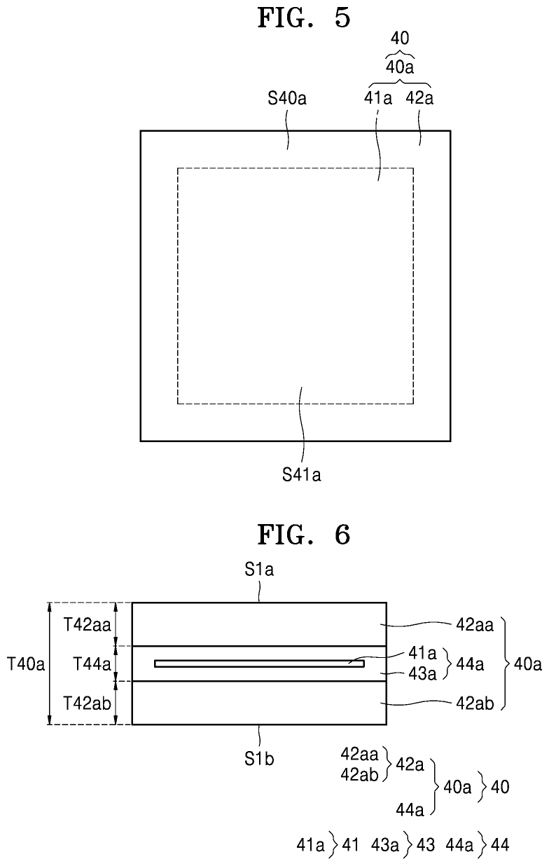

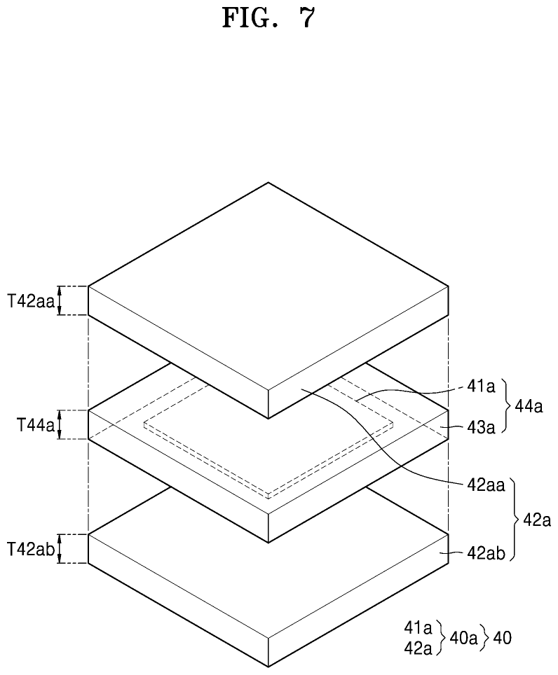

Referring to FIGS. 1 to 9, the heating element 41a may be embedded in the first current collecting member 40a. The first current collecting member 40a includes, for example, a heating element 41a and a first current collector 42a, and part or all of the heating element 41a may be covered by the first current collector 42a. Since part or all of the heating element 41a may be covered by the first current collector 42a, part or all of the heating element 41a may be embedded in the first current collecting member 40a (i.e., embedded in the first current collector 42a). The heating element 41a may not be exposed on the surface of the first current collecting member 40a. The heating element 41a is spaced apart from the first unit cell 1a and the second unit cell 1b by the first current collector 42a. By the heating element 41a being embedded in the first current collecting member 40a, local temperature changes or variations inside the lithium battery 100 including the first collecting member 40a may be more effectively suppressed. Therefore, the lithium battery 100 may maintain a uniform temperature, thereby preventing deterioration of the lithium battery 100 due to uneven temperatures inside the lithium battery 100. Although not shown in the drawings, deterioration such as a short circuit of the lithium battery may occur due to a local temperature increase of the first unit cell 1a and/or the second unit cell 1b, in the lithium battery in which the heating element 41a is in direct contact with the first unit cell 1a and/or the second unit cell 1b. For the sake of convenience, the first current collector 42a by also be referred to as the current collector 42a. Referring to FIGS. 6 to 7, the heating element 41a may be sandwiched between a plurality of current collecting layers 42aa, 42ab comprised in the first current collector 42a. The first current collector 42a may comprise a first current collecting layer 42aa, a second current collector 42ab. The first current collecting member 40a comprises a first current collecting layer 42aa, a second current collector 42ab and the heating layer 44a comprising the heating element 41a and an insulating layer 43a. Thus, the heating layer 44a comprising heating element 41a may be sandwiched between the first current collecting layer 42aa and the second current collector 42ab.

In another embodiment, the heating element may be sandwiched between a plurality of current collecting layers comprised in the first current collector (not shown).

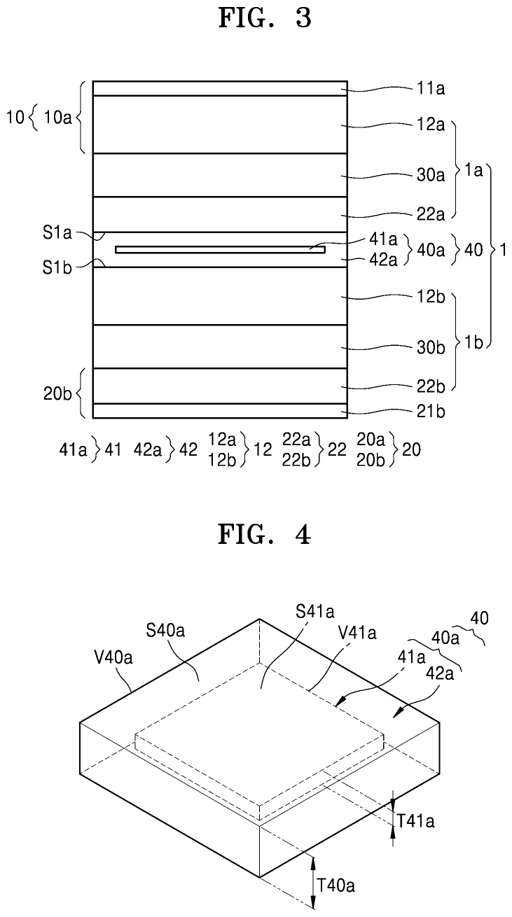

Referring to FIG. 4, the thickness of the heating element T41a may be, for example, about 1% to about 90%, about 1 to about 80%, about 1 to about 70%, about 1 to about 50%, about 1 to about 30%, about 1 to about 20%, or about 1 to about 10% of the total thickness T40a of the first current collecting member. The thickness T41a of the heating element may be, for example, about 0.1 micrometers (μm) to about 500 μm, about 1 μm to about 500 μm, about 1 μm to about 400 μm, about 1 μm to about 300 μm, about 1 μm to about 200 μm, about 1 μm to about 100 μm, about 1 μm to about 80 μm, about 1 μm to about 60 μm, about 1 μm to about 40 μm, about 1 μm to about 20 μm, about 1 μm to about 10 μm, about 1 μm to about 8 μm, about 1 μm to about 6 μm, about 1 μm to about 4 μm, or about 1 μm to about 2 μm. Without wishing to be bound to theory, when the heating element 41a has a thickness within these ranges, cycle characteristics of the lithium battery 100 may be more effectively improved. If the thickness T41a of the heating element 41a is too small, the heat capacity may be reduced, and the temperatures of the heating element 41a for providing the amount of heat required for the lithium battery 100 may excessively increase, thereby deteriorating the heating element 41a. If the thickness T41a of the heating element 41a is too large, the heat capacity may increase, and the power consumption may excessively increase. The heating element 41a may emit heat by electric energy applied from a plurality of electrodes that are spaced apart from and electrically connected to the heating element 41a, although not shown in the drawings. The heating element 41a may similarly be referred to in the collective as heating elements 41, where heating elements 41 of the lithium battery include the heating element 41a.

Referring to FIG. 4, the volume V41a of the heating element 41a may be, for example, about 1% to about 90%, about 1 to about 80%, about 1 to about 70%, about 1 to about 50%, about 1 to about 30%, about 1 to about 20%, or about 1 to about 10% of the total volume V40a of the first current collecting member 40a. Without wishing to be bound to theory, when the heating element 41a has a volume within these ranges, cycle characteristics of the lithium battery 100 may be more effectively improved. If the volume of the heating element 41a is too small, the heat capacity may decrease, and the excess temperature of the heating element 41a for providing the amount of heat required for heating the entire lithium battery 100 may excessively increase, thereby deteriorating the heating element 41a. If the volume V41a of the heating element 41a is too large, the heat capacity may increase, and the power consumption may excessively increase.

Referring to FIGS. 4 and 5, the area S41a of the heating element may be, for example, about 1% to about 100%, about 1% to about 90%, about 1 to about 80%, about 1 to about 70%, about 1 to about 50%, about 1 to about 30%, about 1 to about 20%, or about 1 to about 10% of the total area S40a of the first current collecting member 40a. Without wishing to be bound to theory, when the heating element 41a has an area within these ranges, the cycle characteristics of the lithium battery 100 may be more effectively improved. If the area S41a of the heating element 41a is too small, the heat capacity may decrease, and the temperature of the heating element 41a for providing the amount of heat required for the lithium battery 100 may excessively increase, thereby deteriorating the heating element 41a. If the area S41a of the heating element 41a is too large, the heat capacity may increase, and the power consumption may excessively increase.

As used herein, the area S41a of the heating element 41 is defined as an area occupied by the heating element 41a in the cross section of the first current collecting member 40a including the heating element 41a, obtained by cutting parallel to the first surface S1a, between the first surface S1a and the second surface S1b of the first current collecting member 40a. As used herein, the total area S40a of the first current collecting member 40a is defined as a total area of the cross section of the first current collecting member 40a including the heating element 41a, obtained by cutting parallel to the first surface S1a, between the first surface S1a and the second surface S1b of the first current collecting member 40a.

Although not specifically disclosed in FIGS. 1 to 9, the heating element 41a may include, for example, a matrix and a plurality of fillers (not shown). The filler may be embedded in, for example, the matrix.

The filler may be in the form of, for example, particles (e.g., a plurality of particles). The shape of the particles is not particularly limited. The filler may include, for example, a nanostructure material. As used herein, a “nanostructure material” refers to a material having a nano-sized structure. The filler may include, for example, a one-dimensional nanostructure, a two-dimensional nanostructure, a three-dimensional nanostructure, or a combination thereof.

As used herein, a “one-dimensional nanostructure” refers to a nanostructure in which the shape of a structure is specified by one dimension. For example, the one-dimensional nanostructure may refer to a nanostructure in which the length of one dimension is very large compared to the other two dimensions, such as a rod shape, and the overall size may be determined by the length of one dimension. The one-dimensional nanostructure may be, for example, a nanofiber, a nanotube, a nanorod, or the like.

As used herein, a “two-dimensional nanostructure” refers to a nanostructure in which the shape of the structure is specified by two dimensions. For example, the two-dimensional nanostructure may refer to a nanostructure in which the length of two dimensions are very large compared to the length of the other dimension, such as a flat plate, and the overall size may be determined by the length of the two dimensions. The two-dimensional nanostructure may be, for example, a nanoplate, a nanosheet, a nanoflake, or the like.

As used herein, a “three-dimensional nanostructure” refers to a nanostructure in which the shape of the structure is specified by three dimensions.

The filler may include, for example, a metal, a carbon-containing material, an oxide, a boride, a carbide, a chalcogenide, or a combination thereof.

The filler may include a metal, and the metal may be, for example, copper, silver, tungsten, nickel, chromium, an alloy thereof, or the like, or a combination thereof. For example, the filler may include a copper powder, a silver powder, a tungsten powder, a nickel-chromium alloy powder, or a combination thereof, but embodiments are not limited thereto. Any suitable material that is used as a filler for a heating element in the art may be used.

The filler may include a carbon-containing material, and the carbon-containing material may be, for example, carbon black, a carbon nanotube, a carbon nanofiber, graphene, graphene oxide (GO), reduced graphene oxide (rGO), or the like, or a combination thereof, but embodiments are not limited thereto. Any material that is used in the art as a filler for the heating element 41, 41a may be used.

The filler may include an oxide, and the oxide may be, for example, indium tin oxide (ITO), RuO₍₂₊ₓ₎ (O≤x≤0.1), MnO₂, ReO₂, VO₂, OsO₂, TaO₂, IrO₂, NbO₂, WO₂, GaO₂, MoO₂, InO₂, CrO₂, RhO₂, or the like, or a combination thereof, but embodiments are not limited thereto. Any suitable material that is used in the art as a filler for a heating element may be used.

The filler may include a boride, and the boride may be, for example, Ta₃B₄, Nb₃B₄, TaB, NbB, V₃B₄, VB, or the like, or a combination thereof, but is not limited thereto. Any material that is used in the art as a filler for the heating element 41, 41a may be used.

The filler may include a carbide, and the carbide may be, for example, Dy₂C, Ho₂C, or a combination thereof, but is not limited thereto. Any material that is used in the art as a filler for the heating element 41, 41a may be used.

The filler may include a chalcogenide, and the chalcogenide may be, for example, AuTe₂, PdTe₂, PtTe₂, YTe₃, CuTe₂, NiTe₂, IrTe₂, PrTe₃, NdTe₃, SmTe₃, GdTe₃, TbTe₃, DyTe₃, HoTe₃, ErTe₃, CeTe₃, LaTe₃, TiSe₂, TiTe₂, ZrTe₂, HfTe₂, TaSe₂, TaTe₂, TiS₂, NbS₂, TaS₂, Hf₃Te₂, VSe₂, VTe₂, NbTe₂, LaTe₂, CeTe₂, or the like, or a combination thereof, but embodiments are not limited thereto. Any suitable material that is used in the art as a filler for a heating element may be used.

In one or more embodiments, the filler may include copper, silver, tungsten, a nickel-chromium alloy, carbon black, a carbon nanotube, a carbon nanofiber, graphene, graphene oxide, reduced graphene oxide, indium tin oxide, RuO₂, MnO₂, ReO₂, V₀₂, OsO₂, TaO₂, IrO₂, NbO₂, WO₂, GaO₂, MoO₂, InO₂, CrO₂, RhO₂, Ta₃B₄, Nb₃B₄, TaB, NbB, V₃B₄, Dy₂C, Ho₂C, AuTe₂, PdTe₂, PtTe₂, YTe₃, CuTe₂, NiTe₂, IrTe₂, PrTe₃, NdTe₃, SmTe₃, GdTe₃, TbTe₃, DyTe₃, HoTe₃, ErTe₃, CeTe₃, LaTe₃, TiSe₂, TiTe₂, ZrTe₂, HfTe₂, TaSe₂, TaTe₂, TiS₂, NbS₂, TaS₂, Hf₃Te₂, VSe₂, VTe₂, NbTe₂, LaTe₂, CeTe₂, or a combination thereof.

Referring to FIGS. 1 to 9, the matrix may include an insulator. By the matrix being an insulator, short circuits between the current collector 42a and the heating element 41a may be prevented. The matrix may include a ceramic material having insulation and heat resistance, an organic material having insulation and heat resistance, or a combination thereof.

The ceramic material may include a glass frit. The matrix may include, for example, a glass frit, a polymer, or a combination thereof. The glass frit may include, for example, a silicon oxide, a lithium oxide, a nickel oxide, a cobalt oxide, a boron oxide, a potassium oxide, an aluminum oxide, a titanium oxide, a manganese oxide, a copper oxide, a zirconium oxide, a phosphorus oxide, a zinc oxide, a bismuth oxide, a lead oxide, a sodium oxide, or the like, or a combination thereof.

The glass frit may further include an additive, for example. The additive may include, for example, lithium (Li), nickel (Ni), cobalt (Co), boron (B), potassium (K), aluminum (Al), titanium (Ti), manganese (Mn), copper (Cu), zirconium (Zr), phosphorus (P), zinc (Zn), bismuth (Bi), lead (Pb), sodium (Na), or the like, or a combination thereof.

The organic material having heat resistance may include, for example, a polymer. The melting temperature (Tₘ) of the polymer may be, for example, about 120° C. to about 300° C., about 150° C. to about 300° C., about 150° C. to about 250° C., or about 150° C. to about 200° C. The glass transition temperature (T_{g}) of the polymer may be, for example, about 100° C. to about 300° C., about 100° C. to about 300° C., about 100° C. to about 250° C., or about 100° C. to about 200° C. The polymer may include, for example, an insulating polymer. The polymer may include, for example, a thermoplastic polymer. The polymer may include, for example, polyethylene terephthalate (PET), polyethylene (PE), polypropylene (PP), polybutylene terephthalate (PBT), polyimide (PI), polyphenylene sulfide (PPS), polyamideimide (PAI), a liquid crystalline polymer (LCP), polyether ether ketone (PEEK), a polysiloxane, or the like, or a combination thereof, but embodiments are not limited thereto. Any suitable insulating polymer that is used in the art as the matrix of a heating element may be used.

Referring to FIGS. 1 to 9, the heating element 41a includes, for example, a one-dimensional heating element, a two-dimensional heating element, a three-dimensional heating element, or a combination thereof.

The one-dimensional heating element is a heating element disposed in a one-dimensional manner within the first current collecting member 40a. The one-dimensional heating element may include, for example, a linear heating element, a needle-shaped heating element, or the like, or a combination thereof.

The two-dimensional heating element is a heating element within the first current collecting member 40a and is disposed in a two-dimensional manner. The two-dimensional heating element includes, for example, a planar heating element, a plate-shaped heating element, or the like, or a combination thereof. The two-dimensional heating element may have, for example, a circular shape, an elliptical shape, a square shape, a triangular shape, a pentagonal shape, or the like.

The three-dimensional heating element is a heating element within the first current collecting member 40a and is disposed in a three-dimensional manner. The three-dimensional heating element may be, for example, a heating element in which a plurality of one-dimensional heating elements and/or two-dimensional heating elements are connected in a three-dimensional manner. The two-dimensional heating element may have, for example, a sheet form, a mesh form, or the like, but embodiments are not limited thereto.

Referring to FIGS. 4 and 5, the heating element may be a two-dimensional heating element or a three-dimensional heating element.

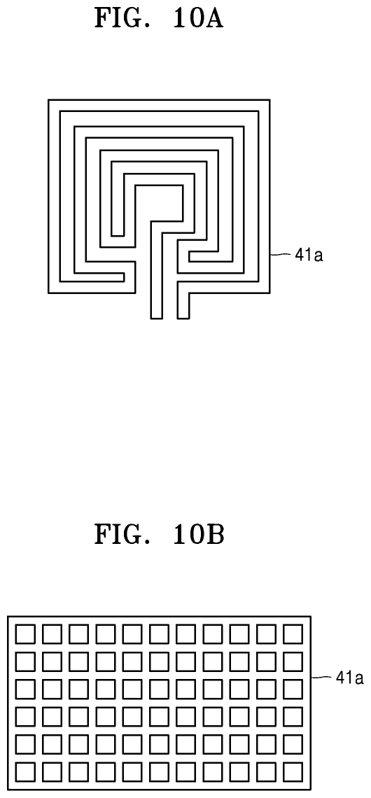

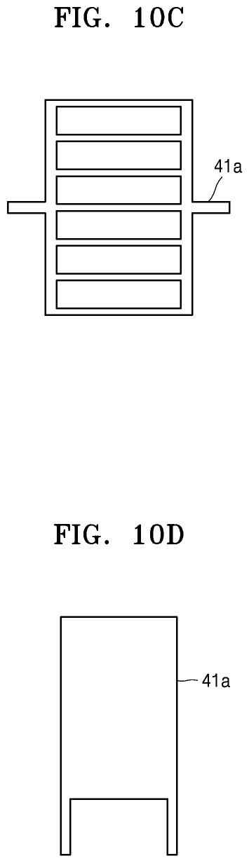

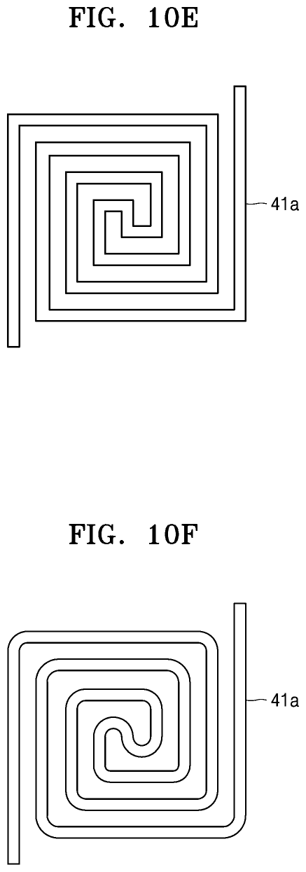

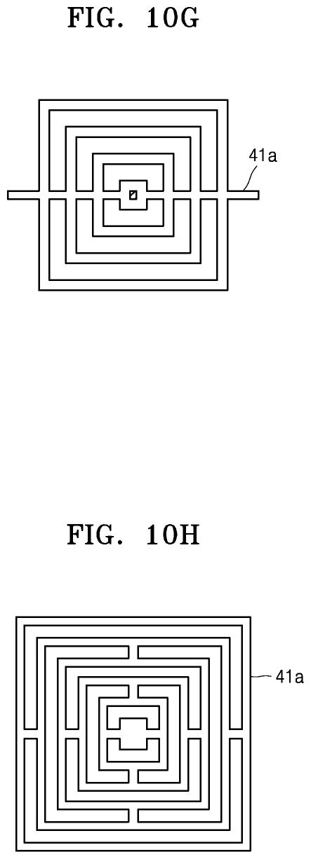

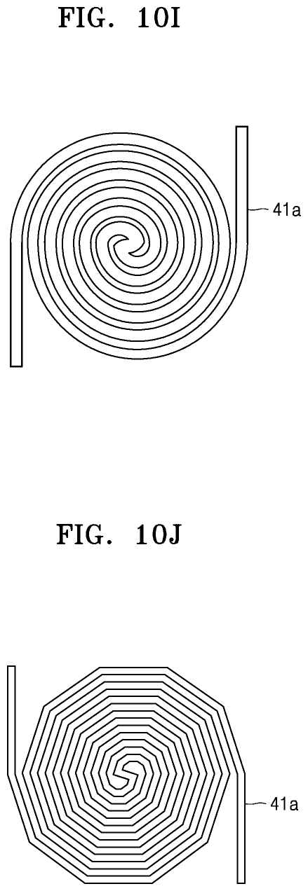

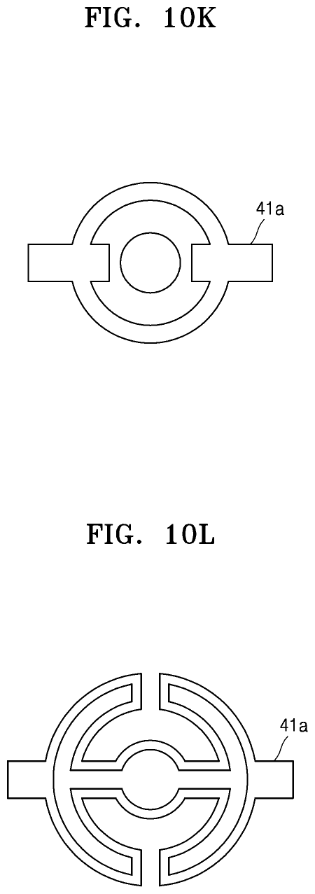

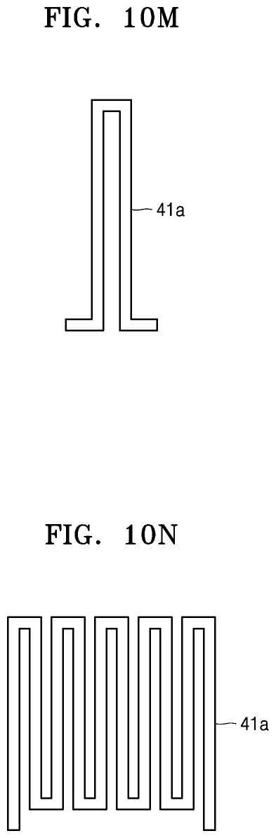

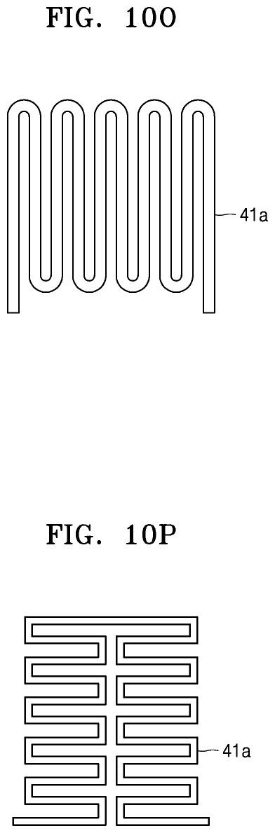

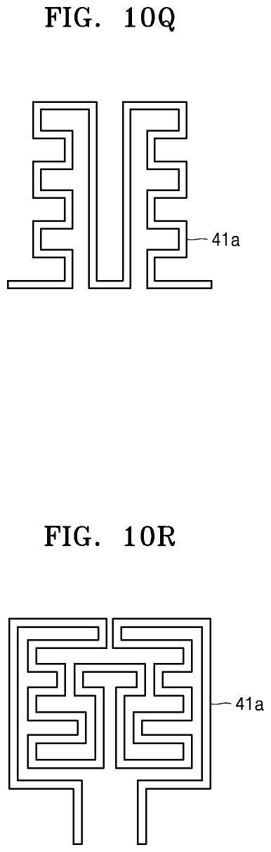

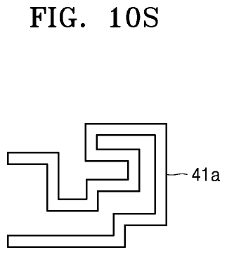

Referring to FIGS. 10A to 10S, the heating element 41a may have a patterned array, for example. The heating element 41a may be regularly and/or periodically arrayed to form a pattern, for example. Without wishing to be bound to theory, when the heating element 41a has a patterned array, the unevenness in temperature within the lithium battery 100 may be more effectively suppressed.

The heating elements 41a may include, for example, a patterned two-dimensional array, a patterned three-dimensional array, or a combination thereof.

The patterned two-dimensional array may be, for example, an array in which one or a plurality of heating elements are regularly and/or periodically arranged and connected to each other to form a pattern.

The patterned three-dimensional array may be, for example, an array in which two-dimensional arrays are additionally disposed in the thickness direction and connected to each other to form a pattern.

The patterned array may include, but is not limited to, for example, a box pattern array, an annular pattern array, a serpentine pattern array, or a combination thereof, and any suitable patterned array that can be used in the art may be used.

The box pattern array may have, for example, one or more patterns selected from FIGS. 10A to 10H. The annular pattern array may have, for example, one or more patterns selected from FIGS. 10I to 10L. The serpentine pattern array may have, for example, one or more patterns selected from FIGS. 10M to 10S.

The heating element 41a may be formed by being patterned or entirely coated on the current collector 42a through a coating process of the composition comprising the matrix material and the filler, and then using a drying process. The current collector 42a may be additionally disposed on the heating element 41a to form a current collecting member. Alternatively, the heating element 41a may be separately produced and may be disposed between the first and second unit cells. The forms of the heating elements are not particularly limited and may be manufactured to have constant forms according to the forms of the current collecting member and the heating position required. The heating elements may have, for example, the above-described patterned arrays.

Referring to FIGS. 6 and 7, the first current collecting member 40a may include, for example, a first current collecting layer 42aa having a first surface, a second current collecting layer 42ab having a second surface, and heating layer 44a disposed between the first current collecting layer 42aa and the second current collecting layer 42ab.

The heating layer 44a includes heating element 41a. The heating element 41a is physically and electrically separated from the first current collecting layer 42aa and the second current collecting layer 42ab.

The heating layer 44a may further include insulating layer 43a in addition to the heating element 41a. When the heating layer 44a comprises both the heating element 41a and the insulating layer 43a, the heating element 41a may or may not include an insulator. The insulating layer 43a may be disposed, for example, between one of the heating element 41a and the first current collecting layer 42aa and between the other of the heating element 41a and the second current collecting layer 42ab. The insulating layer 43a may form heating layer 44a while covering part or all of the heating element 41a. The insulators contained in the insulating layer 43a may be selected from the materials used as the matrixes of the heating elements. By further including the insulating layer 43a within the heating layer 44a, the heating element 41a may be insulated more effectively from the first current collecting layer 42aa and the second current collecting layer 42ab, and a more uniform heating effect may be obtained. When the insulating layer 43a is omitted, the heating element 41a itself may be a heating layer 44a and the heating element 41a comprises matrix as an insulator.

One or more of the first current collecting layer 42aa and the second current collecting layer 42ab may include, for example, a metal. The first current collecting layer 42aa and the second current collecting layer 42ab may be, for example, metal layers.

The metal included in each of the first current collecting layer 42aa and the second current collecting layer 42ab may include, for example, copper, nickel, aluminum, indium, magnesium, titanium, iron, cobalt, zinc, germanium, stainless steel, an alloy thereof, or a combination thereof, but embodiments are not limited thereto, and any suitable metal or metalloid used in the art as a metal or a metalloid that does not form an alloy or compound with lithium may be used.

Referring to FIGS. 6 and 7, the thickness T44a of the heating layer 44a may be, for example, about 1% to about 90%, about 1 to about 80%, about 1 to about 70%, about 1 to about 50%, about 1 to about 30%, about 1 to about 30%, about 1 to about 20%, or about 1 to about 10% of the total thickness T40a of the first current collecting member 40a. The thickness T44a of the heating layer 44a may be, for example, about 0.1 μm to about 500 μm, about 1 μm to about 500 μm, about 1 μm to about 400 μm, about 1 μm to about 300 μm, about 1 μm to about 200 μm, about 1 μm to about 100 μm, about 1 μm to about 80 μm, about 1 μm to about 60 μm, about 1 μm to about 40 μm, about 1 μm to about 20 μm, about 1 μm to about 10 μm, about 1 μm to about 8 μm, about 1 μm to about 6 μm, about 1 μm to about 4 μm, or about 1 μm to about 2 μm, but embodiments are not limited thereto. Without wishing to be bound to theory, when the heating layer 44a has a thickness within these ranges, cycle characteristics of the lithium battery 100 may be further improved. If the thickness T44a of the heating layer 44a is too small, the heat capacity may be reduced, and the temperatures of the heating element 41a for providing the amount of the heat required for the lithium battery 100 may excessively increase, thereby deteriorating the heating elements. If the thickness T44a of the heating layer 44a is too large, the heat capacity may increase, and thus, the power consumption may excessively increase. The heating layer 44a may emit heat by the electric energy applied from a plurality of electrodes that are spaced apart from and electrically connected to the heating element 41a, although not shown in the drawings.

Each of the thickness T42aa of the each of the first current collecting layer 42aa and the thickness T42ab of the second current collecting layer 42ab may be, for example, about 1 nm to about 100 μm, about 50 nm to about 50 μm, about 0.1 μm to about 20 μm, about 0.1 μm to about 10 μm, about 0.1 μm to about 5 μm, about 0.1 μm to about 3 μm, about 0.1 μm to about 2 μm, or about 0.1 μm to about 1 μm.

Without wishing to be bound to theory, by the first current collecting layer 42aa having a thickness within this range, cycle characteristics of the lithium battery 100 may be further improved. By the second current collecting layer 42ab having a thickness within this range, cycle characteristics of the lithium battery 100 may be further improved.

If the thickness T42aa of the first current collecting layer 42aa and the thickness T42ab are too small, cracks may occur during the high-rate charging, and thus, the internal resistance of the lithium battery 100 may increase.

If the thickness T42aa of the first current collecting layer 42aa and the thickness T42ab are too large, the response time of a heating effect may be excessively increased, and thus, the high-rate characteristics of the lithium battery 100 may be lowered.

The thickness T44a of the heating layer 44a may be, for example, about 10% to about 1000%, about 20% to about 900%, about 30% to about 800%, about 40% to about 600%, about 50% to about 400%, about 60% to about 200%, or about 70% to about 150% of the thickness T42aa of the first current collecting layer 42aa.

The thickness T44a of the heating layer 44a may be, for example, about 10% to about 1000%, about 20% to about 900%, about 30% to about 800%, about 40% to about 600%, about 50% to about 400%, about 60% to about 200%, or about 70% to about 150% of the thickness T42ab of the second current collecting layer 42ab.

The thickness T44a of the heating layer 44a may be, for example, about 10% to about 1000%, about 20% to about 900%, about 30% to about 800%, about 40% to about 600%, about 50% to about 400%, about 60% to about 200%, or about 70% to about 150% of a sum of the thickness T42aa of the first current collecting layer 42aa and the thickness T42ab of the second current collecting layer 42ab.

Without wishing to be bound to theory, by the heating layer 44a having a thickness within these ranges, cycle characteristics of the lithium battery 100 may be further improved.

The first current collecting member 40a may be, for example, a flexible film. By being a flexible film, the first current collecting member 40a may be applied to a stack-type battery, a jelly-roll type battery, or the like, but embodiments are not limited thereto. The first current collecting member 40a may be, for example, bent or wound. The first current collecting member 40a may be disposed, for example, between the first and second unit cells and may then be wound at the same time to form an electrode assembly in the form of a jelly-roll.

The first current collecting member 40a may be, for example, a self-standing film. By being a self-standing film, the first current collecting member 40a may not require a separate support or substrate, and thus can be easily applied to various processes during manufacture of the lithium battery 100. For example, after preparing a first roller having a first unit cell wound, a second roller having a second unit cell wound, and a third roller having the first current collecting member 40a wound, respectively, the first unit cell, the first current collecting member 40a, and the second unit cell, which are continuously supplied from the first to third rollers, may be calendared at the same time, thereby continuously manufacturing the electrode assemblies. Therefore, since the lithium battery 100 comprising the first current collecting member 40a may be continuously manufactured without a removal step of the separate support or substrate, the manufacturing cost of the lithium battery 100 may be reduced and the productivity may be improved.

The overall density of the first current collecting member 40a may be less than the density of the metal included in, for example, the first current collecting layer 42aa or the second current collecting layer 42ab. For example, since the first current collecting member 40a includes the first current collecting layer 42aa, the heating layer 44, and the second current collecting layer 42ab, the density of the heating layer 44 may be less than the density of the first current collecting layer 42aa and the density of the second current collecting layer 42ab, the overall density of the first current collecting member 40a may be less than the density of the first current collecting layer 42aa or the density of the second current collecting layer 42ab. For example, the first current collecting member 40a includes the first current collecting layer 42aa, the first heating layer 44a, and the second current collecting layer 42ab. In the first current collecting member 40a, in which the first current collecting layer 42aa and the second current collecting layer 42ab are each a copper foil, and the heating layer 44 includes about 95 weight percent (wt %) of an insulating polymer (PET) and about 5 wt % of a filler, the density of copper is 8.94 grams per centimeter squared (g/cm³), and the density of PET is 1.38 g/cm³, and thus, the overall density of the first current collecting member 40a is lower than the density of the first current collecting layer 42aa or the density of the second current collecting layer 42ab. The overall density of the first current collecting member 40a may be, for example, about 95% or less, about 90% or less, about 80% or less, about 60% or less, about 50% or less, about 30% or less, or about 10% or less of the metal density of the first current collecting layer 42aa or the metal density of the second current collecting layer 42ab. The overall density of the first current collecting member 40a may be, for example, about 1% to about 95%, about 1% to about 90%, about 1% to about 80%, about 1% to about 60%, about 1% to about 50%, about 1% to about 30%, or about 1% to 10% of the metal density of the first current collecting layer 42aa or the metal density of the second current collecting layer 42ab. Without wishing to be bound to theory, by the first collection member 40a having the overall density of these ranges, the energy density per unit weight of the lithium battery 100 may be further increased.

Referring to FIG. 1, in the lithium battery 100, the first surface S1a of the first current collecting member 40a may be in contact with the second electrode active material layer 22a of the first unit cell 1a. The second surface S1b of the first current collecting member 40a may be in contact with the second electrode active material layer 22b of the second unit cell 1b. The second electrode active material layers 22a and 22b are disposed on opposite surfaces of the first current collecting member 40a. A laminate of the second electrode active material layer 22a/the first current collecting member 40a/the second electrode active material layer 22b forms, for example, a mono-polar electrode. In the lithium battery 100, by the mono-polar electrode, the first unit cell 1a and the second unit cell 1b may be laminated in parallel along the thickness direction of the lithium battery 100.

The second electrode active material layers 22a and 22b may be, for example, an anode active material layer. The first current collecting member 40a may be, for example, an anode current collecting member. A laminate of the second electrode active material layer 22a/the first current collecting member 40a/the second electrode active material layer 22b may be, for example, a mono-polar anode. The anode current collecting member 40a includes, for example, a heating element 41a and the anode current collector 42a that covers part or all of the heating element 41a. The anode current collecting member 40a includes anode current collector 42a, and the anode current collector 42a may include, for example, copper, nickel, indium, magnesium, titanium, iron, cobalt, zinc, germanium, stainless steel, an alloy thereof, or a combination thereof, but embodiments are not limited thereto. Specifically, the anode current collector 42a may comprise copper or stainless steel.

Referring to FIG. 1, in the lithium battery 100, the first electrode current collector 11a is disposed on the first electrode active material layer 12a of the first unit cell 1a to form a first electrode 10a, and the first electrode current collector 11b is disposed on the first electrode active material layer 12b of the second unit cell 1b to form a first electrode 10b. The first electrode current collectors 11a, 11b may be, for example, a cathode current collector. The first electrodes 10a, 10b may be, for example, a cathode. Although not shown, part or all of the first electrode current collectors 11a, and 11b may further include a heating element.

Referring to FIGS. 1, 6, and 7, the anode current collecting member may include, for example, a first anode current collecting layer 42aa, a second anode current collecting layer 42ab, and a heating element 41a disposed between the first anode current collecting layer 42aa and the second anode current collecting layer 42ab.

Referring to FIG. 2, in the lithium battery 100, the first surface S1a of the first current collecting member 40a may be in contact with the first electrode active material layer 12a of the first unit cell 1a, and the second surface S1b of the first current collecting member 40a may be in contact with the first electrode active material layer 12b of the second unit cell 1b. The first electrode active material layers 12a, 12b are disposed on both surfaces of the first current collecting member 40a. A laminate of the first electrode active material layer 12a/the first current collecting member 40a/the first electrode active material layer 12b may form, for example, a mono-polar electrode. In the lithium battery 100, by the mono-polar electrode, the first unit cell 1a and the second unit cell 1b may be laminated in parallel along a thickness direction of the lithium battery 100.

The first electrode active material layers 12a, 12b may be, for example, a cathode active material layer. The first current collecting member 40a may be, for example, a cathode current collecting member. The laminate of the first electrode active material layer 12a/the first current collecting member 40a/the first electrode active material layer 12b may be, for example, a mono-polar cathode. The first current collecting member 40a may be, for example, a cathode current collecting member. The cathode current collecting member 40a may include, for example, a heating element 41a and a cathode current collecting member 42a, and the cathode current collector 42a may cover part or all of the heating element 41a. The cathode current collecting member 40a includes a cathode current collector 42a, and the cathode current collector 42a may include aluminum, indium, magnesium, titanium, iron, cobalt, zinc, germanium, stainless steel, an alloy thereof, or a combination thereof, but embodiments are not limited thereto. The cathode current collecting member 42a may be, for example, aluminum or the like.

Referring to FIG. 2, in the lithium battery 100, the second electrode current collector 21a may be disposed on the second electrode active material layer 22a of the first unit cell 1a to form a second electrode 20a, and the second electrode current collector 21b may be disposed on the second electrode active material layer 22b of the second unit cell 1b to form a second electrode 20b. The second electrode current collectors 21a, 21b may be, for example, an anode current collector. The second electrodes 20a, 20b may be, for example, an anode. Although not shown, part or all of the second electrode current collectors 21a, 21b may additionally include a heating element.

Referring to FIGS. 2, 6 and 7, the cathode current collecting member 40a includes, for example, a first cathode current collecting layer 42aa, a second cathode current collecting layer 42ab, and a heating layer 44a disposed between the first cathode current collecting layer 42aa and the second cathode current collecting layer 42ab.

Referring to FIG. 3, in the lithium battery 100, the first surface S1a of the first current collecting member 40a may be in contact with the second electrode active material layer 22a of the first unit cell 1a, and the second surface S1b of the first current collecting member 40a may be in contact with the first electrode active material layer 12b of the second unit cell 1b. The first electrode active material layer 12b and the second electrode active material layer 22a are disposed on opposite surfaces of the first current collecting member 40a, respectively. A laminate of the second electrode active material layer 22a/the first current collecting member 40a/the first electrode active material layer 12b may form, for example, a bi-polar electrode. In the lithium battery 100, by the bi-polar electrode, the first unit cell and the second unit cell may be laminated in series along the thickness direction of the lithium battery 100.

The second electrode active material layers 22a, 22b may be, for example, an anode active material layer. The first electrode active material layers 12a, 12b may be, for example, a cathode active material layer. The first current collecting member 40a may be, for example, a bi-polar current collecting member. A laminate of the second electrode active material layer 22a/the first current collecting member 40a/the first electrode active material layer 12b may be, for example, a bi-polar electrode.

Referring to FIG. 3, in the lithium battery 100, the first electrode current collector 11a may be disposed on the first electrode active material layer 12a of the first unit cell 1a to configure the first electrode 10a. The first electrode current collector 11a may be, for example, a cathode current collector. The first electrode 10a may be, for example, a cathode. In the lithium battery 100, the second electrode current collector 21b may be disposed on the second electrode active material layer 22b of the second unit cell 1b to configure the second electrode 20b. The second electrode current collector 21b may be, for example, an anode current collector. The second electrode 20b may be, for example, an anode. Although not shown, part or all of the first electrode current collector 11a and the second electrode current collector 21b may further include a heating element.

Alternatively, the first electrode active material layers 12a, 12b may be, for example, an anode active material layer. The second electrode active material layers 22a, 22b may be, for example, a cathode active material layer. The first current collecting member 40a may be, for example, a bi-polar current collecting member. A laminate of the first electrode active material layer 12a/the first current collecting member 40a/the second electrode active material layer 22b may be, for example, a bi-polar electrode.

The first electrode current collecting member includes, for example, a heating element and an electrode collector 42, 42a, and the electrode collector 42 and 42a covers part or all of the heating element.

The first current collecting member 40a includes an electrode current collector 42a, and the electrode current collector 42a may include, for example, aluminum, copper, indium, magnesium, titanium, iron, cobalt, zinc, germanium, stainless steel, an alloy thereof, or a combination thereof, but embodiments are not limited thereto.

Alternatively, although not shown, the first surface S1a of the first current collecting member 40a may be in contact with the first electrode active material layer 12a of the first unit cell 1a, and the second surface S1b of the first current collecting member 40a may be in contact with the second electrode active material layer 22b of the second unit cell 1b.

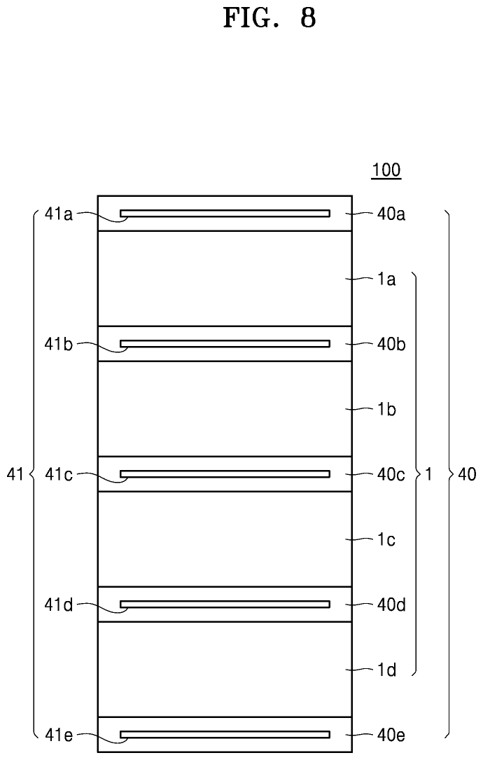

Referring to FIG. 8, the lithium battery 100 may include a plurality of unit cells 1a, 1b, 1c, and 1d stacked in the thickness direction of the lithium battery 100; and a plurality of current collecting members 40a, 40b, 40c, 40d, and 40e disposed between each of the plurality of unit cells 1a, 1b, 1c, and 1d, and each of the plurality of current collecting members 40a, 40b, 40c, 40d, and 40e may include a heating element 41a, 41b, 41c, 41d, and 41e. By each of the plurality of current collecting members 40a, 40b, 40c, 40d, and 40e including the heating elements 41a, 41b, 41c, 41d, and 41e the cycle characteristics of the lithium battery 100 may be further improved. The plurality of unit cells 1a, 1b, 1c, and 1d may include, for example, a first unit cell 1a, a second unit cell 1b, a third unit cell 1c, and a fourth unit cell 1d. The plurality of current collecting members 40a, 40b, 40c, 40d, and 40e may include, for example, a first current collecting member 40a, a second current collecting member 40b, a third current collecting member 40c, a fourth current collecting member 40d, and a fifth current collecting member 40e.

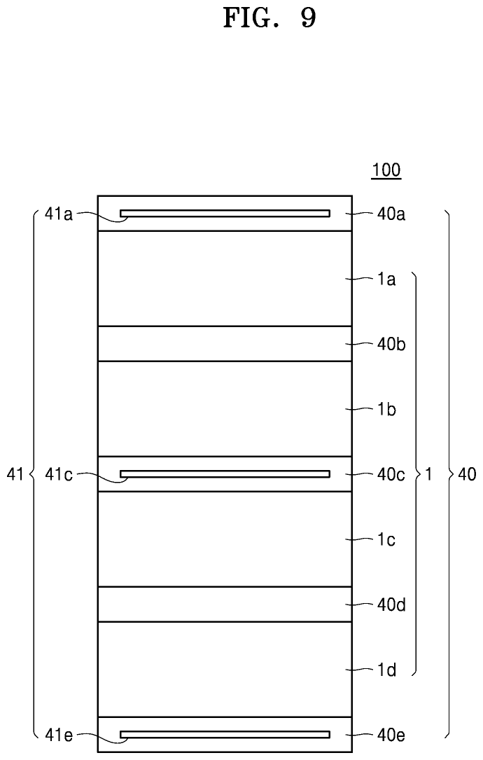

Referring to FIG. 9, the lithium battery 100 may include a plurality of unit cells 1a, 1b, 1c, and 1d stacked in the thickness direction of the lithium battery 100; and a plurality of current collecting members 40a, 40b, 40c, 40d, and 40e disposed between the plurality of unit cells 1a, 1b, 1c, and 1d, and, among the plurality of current collecting members 40a, 40b, 40c, 40d, and 40e, the proportion of the current collecting members 40a to 40e including a heating element 41, may be about 50% or less, about 40% or less, about 30% or less, about 20% or less, or about 10% or less. By the lithium battery 100 having the proportion of the current collecting members 40 each including the heating element 41 within this range, cycle characteristics of the lithium battery 100 may be further improved while suppressing the energy used for heating.

Referring to FIGS. 8 and 9, the current collecting members 40 including heating elements 41 may be disposed at regular intervals, for example, along the thickness direction of the lithium battery 100. Since the current collecting members 40 including the heating elements 41 are disposed at a regular interval along the thickness direction of the lithium battery 100, uniform heat generation may be provided within the lithium battery 100. The interval between the current collecting members 40 including the heating elements 41 disposed between the plurality of unit cells 1a, 1b, 1c, and 1d stacked in the thickness direction may be, for example, 1 to about 100 unit cells, 1 to about 50 unit cells, 1 to about 20 unit cells, 1 to about 10 unit cells, 1 to about 5 unit cells, or 1 to 3 unit cells.

Referring to FIGS. 1 to 9, the current collecting members 40 including the heating elements 41 may be disposed, for example, inside the lithium battery 100. For example, the lithium battery 100 of FIGS. 1 to 9 may be sealed by an exterior material (not shown), and, by such an exterior material, the heat generating effect of the heating elements 41 may be further improved by sealing the lithium battery 100.

By the lithium battery 100 including the current collecting member, at ambient room temperature (about 25° C.) and atmospheric pressure (about 1 atm), the temperature of the current collecting member 40a during charging and discharging cycles of the lithium battery 100, may be, for example, about 40° C. to about 100° C., about 50° C. to about 90° C., about 50° C. to about 80° C., or about 50° C. to about 70° C. Without wishing to be bound to theory, by the current collecting member having the temperature in such a range, the cycle characteristics of the lithium battery 100 may be further improved.

By the lithium battery 100 including the current collecting member, in an atmosphere of ambient room temperature (about 25° C.) and atmospheric pressure (1 atm), a charging time to about 80% of the state of charge (SOC) of the lithium battery 100 may be about 20 minutes or less, about 15 minutes or less, about 10 minutes or less, or about 5 minutes or less. By the lithium battery 100 having such high-speed charging performance, the charging time of the lithium battery 100 may be significantly reduced. For example, the charging time of an electric vehicle may be significantly reduced. The lithium battery 100 may be stably charged and discharged for more than about 1000 cycles, more than about 5000 cycles, or more than about 10000 cycles without a short circuit at a high charging rate within this range. The lithium battery 100 may provide stable charging/discharging cycles for a long period of time while performing high-speed charging.

### Lithium Battery: Cathode Active Material Layer

Referring to FIGS. 1 to 9, the first electrode active material layer 12a, 12b or the second electrode active material layer 22a, 22b may be, for example, a cathode active material layer.

Any suitable cathode active material may be used without limitation, as long as it is used in a lithium battery. For example, a lithium transition metal oxide or a transition metal sulfide may be used. For example, at least one of a composite oxide of lithium and a metal that is cobalt, manganese, nickel, or a combination thereof may be used, and specific examples thereof include a compound represented by any one of the following chemical formulae: LiₐA_{1-b}B′_{b}D₂ (where 0.90≤a≤1.8 and 0≤b≤0.5); LiₐE_{1-b}B′_{b}O_{2-c}D_{c} (where 0.90≤a≤1.8, 0≤b≤0.5, and 0≤c≤0.05); LiE_{2-b}B′_{b}O_{4-c}D_{c} (where 0≤b≤0.5 and 0≤c≤0.05); LiₐNi_{1-b-c}Co_{b}B′_{c}Dₐ (where 0.90≤a≤1.8, 0≤b≤0.5, 0≤c≤0.05, and 0<α≤2); LiₐNi_{1-b-c}Co_{b}B′_{c}O_{2-α}F′_{α} (where 0.90≤a≤1.8, 0≤b≤0.5, 0≤c≤0.05, and 0<α<2); LiₐNi_{1-b-c}Co_{b}B′_{c}O_{2-α}F₂ (where 0.90≤a≤1.8, 0≤0.5≤b≤0.5, 0<c≤0.05, and 0<α<2); LiₐNi_{1-b-c}Mn_{b}B′_{c}Dα (where 0.90≤a≤1.8, 0≤b≤0.5, 0≤c≤0.05, and 0<α≤2); LiₐNi_{1-b-c}Mn_{b}B′_{c}O_{2-α}F′_{α} (where 0.90≤a≤1.8, 0≤b≤0.5, 0≤c≤0.05, and 0<α<2); LiₐNi_{1-b-c}Mn_{b}B′_{c}O_{2-α}F₂ (where 0.90≤a≤1.8, 0≤b≤0.5, 0≤c≤0.05, and 0<α<2); LiₐNi_{b}E_{c}GdO₂ (where 0.90≤a≤1.8, 0≤b≤0.9, 0≤c≤0.5, and 0.001≤d≤0.1); LiₐNi_{b}Co_{c}Mn_{d}GeO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂GbO₄ (where 0.90≤a≤1.8 and 0.001≤b≤0.1); QO₂; QS₂; LiQS₂; V₂O₅; LiV₂O₂; Lil′O₂; LiNiVO₄; Li_{(3-f)}J₂(PO₄)₃ (where 0≤f≤2); Li_{(3-f)}Fe₂(PO₄)₃ (where 0≤f≤2); LiFePO₄, or a combination thereof. In the above chemical formulae A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof. For example, LiCoO₂, LiMnxO₂ₓ(x=1, 2), LiNi₁₋ₓMnₓO₂ₓ(0<x<1), Ni_{1-x-y}CoₓMn_{y}O₂ (0≤x≤0.5, 0≤y≤0.5), LiFePO₄, TiS₂, FeS₂, TiS₃, FeS₃, or a combination thereof may be used.

For example, the cathode active material may be a compound represented by at least one of chemical formulae 1 to 8:

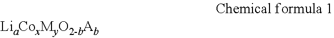

wherein in chemical formula 1,

1.0≤a≤1.2, 0≤b≤0.2, 0.9≤x≤1,0≤y≤0.1, and x+y=1,
M is manganese, niobium, vanadium, magnesium, gallium, silicon, tungsten, molybdenum, iron, chromium, copper, zinc, titanium, aluminum, boron, or a combination thereof, and
A is F, S, Cl, Br, or a combination thereof,

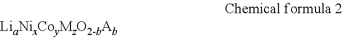

wherein in chemical formula 2,

1.0≤a≤1.2, 0≤b≤0.2, 0.8≤x<1, 0≤y≤0.3, 0<z≤0.3, and x+y+z=1,
M is manganese, niobium, vanadium, magnesium, gallium, silicon, tungsten, molybdenum, iron, chromium, copper, zinc, titanium, aluminum, boron, or a combination thereof, and
A is F, S, Cl, Br, or a combination thereof,

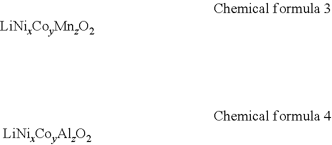

wherein in chemical formulae 3 and 4,

0.8≤x≤0.95, 0≤y≤0.2, 0<z≤0.2, and x+y+z=1,

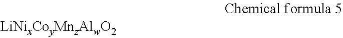

wherein in chemical formula 5,

0.8≤x≤0.95, 0≤y≤0.2, 0<z≤0.2, 0<w≤0.2, and x+y+z+w=1,

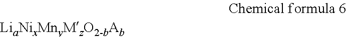

wherein in chemical formula 6,

1.0≤a≤1.2, 0≤b≤0.2, 0<x≤0.3, 0.5≤y<1, 0<z≤0.3, and x+y+z=1,
M′ is cobalt, niobium, vanadium, magnesium, gallium, silicon, tungsten, molybdenum, iron, chromium, copper, zinc, titanium, aluminum, boron, or a combination thereof,
A is F, S, Cl, Br, or a combination thereof,

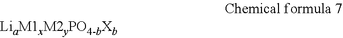

wherein in chemical formula 7,

0.90≤a≤1.1, 0≤x≤0.9, 0≤y≤0.5, 0.9<x+y<1.1, and 0≤b≤2,
M1 is chromium, manganese, iron, cobalt, nickel, copper, zirconium, or a combination thereof,
M2 is magnesium, calcium, strontium, barium, titanium, zinc, boron, niobium, gallium, indium, molybdenum, tungsten, aluminum, silicon, chromium, vanadium, scandium, yttrium, or a combination thereof, and
X is O, F, S, P, or a combination thereof, and

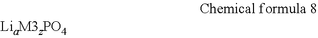

wherein in chemical formula 8,

0.90≤a≤1.1 and 0.9≤z≤1.1, and
M3 is chromium, manganese, iron, cobalt, nickel, copper, zirconium, or a combination thereof.

The cathode active material layer may further include a conducting agent and a binder.

The conducting agent may include, for example, carbon black, carbon fiber, graphite, or the like, or a combination thereof. The carbon black may be, for example, acetylene black, Ketjen black, super P carbon, channel black, furnace black, lamp black, thermal black, or the like, or a combination thereof. The graphite may be natural graphite or artificial graphite. Combinations including at least one of the foregoing may be used. The cathode active material layer may additionally include an additional conducting agent other than the foregoing carbonaceous conducting agents. The additional conducting agent may include electrically conductive fibers such as metal fibers; metal powder such as a fluorocarbon powder, aluminum powder, or nickel powder; conductive whiskers such as zinc oxide, potassium titanate, or the like; or polyethylene derivatives. Combinations including at least one of the foregoing additional conducting agents may be used. The amount of the conducting agent may be about 1 to about 10 parts by weight, or about 2 to about 7 parts by weight, on the basis of 100 parts by weight of the cathode active material. Without wishing to be bound to theory, when the amount of the conducting agent is within this range, for example, from about 1 to about 10 parts by weight, the electrical conductivity of the cathode active material layer may be appropriate.

The binder may improve the adhesion between components of the cathode active material layer and the adhesion to the current collecting member of the cathode active material layer. Examples of the binder may include polyacrylic acid (PAA), polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene monomer (EPDM), sulfonated EPDM, styrene-butadiene-rubber, fluorinated rubber, a copolymer thereof, or the like, or a combination thereof. The amount of the binder may be about 1 to about 10 parts by weight or about 2 to about 7 parts by weight with respect to 100 parts by weight of the cathode active material. Without wishing to be bound to theory, when the amount of the binder is within this range, the adhesion of the cathode active material layer to the current collecting member may be further improved, and the decrease in energy density of the cathode active material layer may be suppressed.

### Lithium Battery: Electrolyte Layer

Referring to FIGS. 1 to 9, the electrolyte layer may include a solid electrolyte, a liquid electrolyte, or a combination thereof.

The thickness of the electrolyte layer may be, for example, about 500 μm or less, about 300 μm or less, about 100 μm or less, or about 50 μm or less. The thickness of the electrolyte layer 30 may be, for example, about 1 μm to about 500 μm, about 5 μm to about 300 μm, about 5 μm to about 100 μm, or about 5 μm to about 50 μm.

The electrolyte layer may have a multilayer structure including, for example, one or more solid electrolyte layers and one or more liquid electrolyte layers. The electrolyte layer may have, for example, a two-layer structure of a solid electrolyte layer/liquid electrolyte layer.

### Solid Electrolyte Layer

The electrolyte layer may be, for example, a solid electrolyte layer.

The solid electrolyte layer may include, for example, an oxide-containing solid electrolyte, a sulfide-containing solid electrolyte, a halide-containing solid electrolyte, or a combination thereof.

The solid electrolyte layer may be, for example, liquid impermeable. Therefore, in a lithium battery in which the cathode active material layer includes a cathode electrolyte, the cathode electrolyte cannot pass through the solid electrolyte layer.

The oxide containing solid electrolyte may include, for example, lithium phosphorus oxynitride (LiPON), Li₃ₓLa_{(2/3-x)(1/3-2x)}TiO₃ (where 0.04<x<0.16), Li₁₊ₓAlₓTi₂₋ₓ (PO₄)₃ (where 0<x<2), Li₁₊ₓ AlₓGe₂₋ₓ(PO₄)₃ (where 0<x<2), Li₁₊ₓ+_{y}AlₓTi₂₋ₓSi_{y}P_{3-y}O₁₂ (where 0<x<2 and 0≤y<3), BaTiO₃, Pb(Zr, Ti)O₃, Pb₁₋ₓLaₓZr_{1-y}Ti_{y}O₃ (where 0<x<1 and 0≤y<1), Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(Al, Ga)ₓ(Ti, Ge)₂₋ₓSi_{y}P_{3-y}O₁₂ (where 0≤x≤1 and 0≤y≤1), LiₓLa_{y}TiO₃ (where 0<x<2 and 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (where M is Te, Nb, Zr, or a combination thereof, and 1≤x≤10), Li₇La₃Zr₂O₁₂, Li₃₊ₓ La₃Zr₂₋ₐMₐO₁₂, (where M is Ga, W, Nb, Ta, Al, or a combination thereof, 0<a<2, and 1≤x≤10), or a combination thereof. The solid electrolyte may be prepared by, for example, a sintering process. The oxide-containing solid electrolyte may be, for example, a garnet-type solid electrolyte that may be one of Li₇La₃Zr₂O₁₂ (LLZO) or Li₃₊ₓ La₃Zr₂₋ₐMₐO₁₂ (where M doped LLZO, M is Ga, W, Nb, Ta, Al, or a combination thereof, 0<a<2, and 1≤x≤10).

The oxide-containing solid electrolyte may be, for example, crystalline, amorphous, glassy, or glass-ceramic. The oxide-containing solid electrolyte may have various crystal states depending on the manufacturing method and composition.

The sulfide-containing solid electrolyte may include, for example, a lithium sulfide, a silicon sulfide, a phosphorus sulfide, a boron sulfide, or the like, or a combination thereof. The sulfide-containing solid electrolyte particles may include Li₂S, P₂S₅, SiS₂, GeS₂, B₂S₃, or the like, or a combination thereof. The sulfide-containing solid electrolyte particles may be Li₂S or P₂S₅. The sulfide-containing solid electrolyte particles are known to have higher lithium-ion conductivity than other inorganic compounds. For example, the sulfide-containing solid electrolyte particles may include Li₂S and P₂S₅. When the sulfide solid electrolyte material constituting the solid electrolyte includes Li₂S—P₂S₅, the mixing molar ratio of Li₂S to P₂S₅ may be, for example, about 50:50 to about 90:10. The sulfide-containing solid electrolyte may also include an inorganic solid electrolyte prepared by adding Li₃PO₄, a halogen, a halogen compound, Li₂₊₂ₓZn₁₋ₓGeO₄ (“LISICON”), Li_{3+y}PO₄₋ₓNₓ (“LIPON”), Li_{3.25}Ge_{0.25}P_{0.75}S₄ (“Thio-LISICON”), or Li₂O—Al₂O₃—TiO₂—P₂O₅ (“LATP”) to an inorganic solid electrolyte of Li₂S—P₂S₈, SiS₂, GeS₂, B₂S₃, or a combination thereof. Non-limiting examples of the sulfide solid electrolyte material include Li₂S—P₂S₅; Li₂S—P₂S₅—LiX (where X is a halogen element); Li₂S—P₂S₅—Li₂O; Li₂S—P₂S₅—Li₂O-Lil; Li₂S—SiS₂; Li₂S—SiS₂-Lil; Li₂S—SiS₂—LiBr; Li₂S—SiS₂—LiCl; Li₂S—SiS₂—B₂S₃-Lil; Li₂S—SiS₂—P₂S₅-Lil; Li₂S—B₂S₃; Li₂S—P₂S₅—ZₘSₙ (where m and n are positive numbers, and Z is Ge, Zn, G, or a combination thereof); Li₂S—GeS₂; Li₂S—SiS₂—Li₃PO₄; and Li₂S—SiS₂-LiₚMO_{q} (where p and q are positive numbers, and M is P, Si, Ge, B, Al, Ga, In, or a combination thereof). In this regard, the sulfide-containing solid electrolyte material may be prepared by treating raw starting materials (for example, Li₂S, P₂S₅, or the like) of the sulfide-containing solid electrolyte material by a melt quenching method, a mechanical milling method, or the like. In addition, a calcination process may be performed after the treatment.

The halide-containing solid electrolyte may include, for example, a halogen element as a main component of an anion. Including a halogen element as a main component of the anion means that the ratio (molar ratio) of the halogen element is highest among all anions constituting the halide solid electrolyte. The ratio of the halogen (X) element to all anions constituting the halide solid electrolyte may be, for example, about 50 mole percent (mol %) or greater, about 70 mol % or greater, about 90 mol % or greater, or about 100 mol %. One or more types of halogen elements may be used. The halide solid electrolyte may not include, for example, a sulfur (S) element. The halide solid electrolyte may contain, for example, a Li element, an M element (where M is a metal other than Li), and an X element. X may be, for example, F, Cl, Br, I, or a combination thereof. The halide solid electrolyte may include, for example, Br or Cl, as X. The halide solid electrolyte may include, for example, a metal element such as Sc, Y, B, Al, Ga, In, or a combination thereof as M. The composition of the halide solid electrolyte may be, for example, Li₆₋₃ₐMₐBr_{b}Cl_{c} (where M is a metal other than Li, 0<a<2, 0≤b≤6, 0≤c≤6, and b+c=6). The halide solid electrolyte may be, for example, Li₃YBr₆, Li₃YCl₆, Li₃YBr₂Cl₄, or the like, but embodiments are not limited thereto. The halide solid electrolyte may be, for example, a particulate material. The average particle diameter (D50) of the halide solid electrolyte may be, for example, about 0.05 μm to about 50 μm, or about 0.1 μm to about 20 μm.

The solid electrolyte layer may be provided in the form of, for example, a solid electrolyte sheet or a solid electrolyte thin film, but embodiments are not limited thereto. Alternatively, the solid electrolyte layer may be prepared by mixing the solid electrolyte and other components.

The solid electrolyte layer may be prepared, for example, by mixing and drying the above-described solid electrolyte and a binder, or by pressing and/or sintering the above-described solid electrolyte powder in a certain form. The solid electrolyte layer may be prepared, for example, by mixing and drying a sulfide-containing, oxide-containing, and/or halide-containing solid electrolyte and a binder, or pressurizing and/or sintering a sulfide-containing, oxide-containing, and/or halide-containing solid electrolyte powder into a certain form.

The solid electrolyte may be deposited using a film formation method such as, for example, blasting, aerosol deposition, cold spraying, sputtering, chemical vapor deposition (CVD), and/or spraying, and, accordingly, a solid electrolyte layer may be prepared. In addition, the solid electrolyte layer may be formed by pressurizing a solid electrolyte. In addition, the solid electrolyte layer may be formed by mixing and pressurizing a solid electrolyte, a solvent, and a binder or support. In this case, the solvent or support is added to reinforce the strength of the solid electrolyte layer or to prevent a short-circuit of the solid electrolyte.

The binder included in the solid electrolyte layer may be, for example, styrene butadiene rubber (SBR), polytetrafluoroethylene, poly(vinylidene fluoride), polyethylene, polyvinyl alcohol, or the like, but embodiments are not limited thereto, and any suitable binder can be used as long as it is used as a binder in the art. The binder of the solid electrolyte layer may be the same as or different from the binder of the cathode and/or the anode.

### Liquid Electrolyte Layer

The liquid electrolyte layer includes, for example, an organic electrolyte solution. The organic electrolyte solution is prepared, for example, by dissolving a lithium salt in an organic solvent.

Any suitable organic solvent may be used, including those used as an organic solvent in the art. The organic solvent may include, for example, propylene carbonate, ethylene carbonate, fluoroethylene carbonate, butylene carbonate, dimethyl carbonate, diethyl carbonate, methyl ethyl carbonate, methyl propyl carbonate, ethyl propyl carbonate, methyl isopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethylformamide, dimethylacetamide, dimethyl sulfoxide, dioxane, 1,2-dimethoxyethane, sulfolane, dichloroethane, chlorobenzene, nitrobenzene, diethylene glycol, dimethyl ether, or the like, or a combination thereof.

Any suitable lithium salt may be used, including those used as a lithium salt in the art. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are each a natural number of 1 to 20), LiCl, Lil, or the like, or a combination thereof.

The liquid electrolyte layer may include a separator. The liquid electrolyte layer may be formed by impregnating the organic electrolyte into the separator.

Any suitable separator may be used, including those commonly used in a lithium battery. As the separator, a separator having a low resistance to migration of ions in an electrolyte and having an excellent electrolyte-retaining ability may be used. Non-limiting examples of the separator include glass fiber, polyester, polyethylene, polypropylene, polytetrafluoroethylene (PTFE), or the like, or a combination thereof, each of which may be a non-woven or woven fabric. For lithium ion batteries, for example, a rollable separator such as polyethylene or polypropylene may be used, and for lithium ion polymer batteries, a separator having excellent organic electrolyte impregnating ability may be used.

The separator may be manufactured by the following exemplary method, but is not necessarily limited to this method and may be adjusted according to required conditions.

First, a separator composition may be prepared by mixing a polymer resin, a filler, and a solvent. The separator composition may be directly coated on top of the electrode and dried to form a separator. Alternatively, after the separator composition may be cast and dried on a support, the separator film peeled off from the support may be laminated on top of the electrode to form a separator.

The polymer used in manufacturing the separator is not particularly limited, and any suitable polymer that is used for a binder of an electrode plate may be used. For example, vinylidene fluoride/hexafluoropropylene copolymer, polyvinylidene fluoride (PVDF), polyacrylonitrile, polymethyl methacrylate, or the like, or a combination thereof, may be used.

### Lithium Battery: Anode Active Material Layer

Referring to FIGS. 1 to 9, the first electrode active material layers 12a, 12b or the second electrode active material layers 22a, 22b may be, for example, an anode active material layer.

### Anode Active Material Layer Containing Lithium Metal

The anode active material layer may include, for example, lithium metal, a lithium alloy, or a combination thereof as an anode active material. When lithium metal, a lithium alloy, or a combination thereof is included as an anode active material, a binder and a conductive material may not be included.

The anode active material layer may include, for example, lithium foil, lithium powder, plated lithium, a lithium alloy, or a combination thereof. The anode active material layer including lithium foil may be, for example, a lithium metal layer. The anode active material layer including lithium powder may be introduced by coating a slurry including lithium powder and a binder on the anode current collector. The binder may be, for example, a fluorine-containing binder such as polyvinylidene fluoride (PVDF). The anode active material layer may not include a carbon-containing anode active material. Accordingly, the anode active material layer may be made of a metal-containing anode active material. The anode active material layer may also be a plated lithium metal layer. The lithium alloy may be, for example, a Li—Al alloy, a Li—Sn alloy, a Li—In alloy, a Li—Ag alloy, a Li—Au alloy, a Li—Zn alloy, a Li—Ge alloy, a Li—Si alloy, or the like, or a combination thereof, but embodiments are not limited thereto, and any suitable lithium alloy may be used, including those used as a lithium alloy in the art. After manufacturing a lithium battery by assembling an anode not including an anode active material layer, a cathode, and an electrolyte, a lithium metal layer precipitated between the current collecting member and the electrolyte layer due to charging may be further included as an anode active material layer.

The thickness of the anode active material layer may be, for example, about 0.1 μm to about 100 μm, about 0.1 μm to about 80 μm, about 1 μm to about 80 μm, or about 10 μm to about 80 μm, but embodiments are not necessarily limited to this range, and may be adjusted according to the required form, dosage, or the like of lithium battery. If the thickness of the anode active material layer is excessively increased, the structural stability of the lithium battery may deteriorate, and side reactions may increase. If the thickness of the anode active material layer is too small, the energy density of the lithium battery may decrease. The thickness of the lithium foil may be, for example, about 1 μm to about 50 μm, about 1 μm to about 30 μm, about 10 μm to about 30 μm, or about 10 μm to about 80 μm. Since the lithium foil has a thickness within this range, lifespan characteristics of a lithium battery including a protective layer may be further improved. The (D50) particle size of the lithium powder may be, for example, about 0.1 μm to about 3 μm, about 0.1 μm to about 2 μm, or about 0.1 μm to about 2 μm. The thickness of the lithium precipitation layer may be, for example, about 1 μm to about 80 μm, or 10 μm to about 80 μm. Without wishing to be bound to theory, since the lithium powder has a thickness within this range, lifespan characteristics of a lithium battery including a protective layer may be further improved.

Anode Active Material Layer Containing Carbon-Containing Material and/or Metal-Containing Material

The anode active material layer includes, for example, an anode active material.

Any suitable anode active material may be used, including those used as an anode active material for a lithium battery in the art. For example, the anode active material includes at least one of a lithium metal, a metal alloyable with lithium, a transition metal oxide, a non-transition metal oxide, or a carbon-containing material. The metal alloyable with lithium may be, for example, Si, Sₙ, Al, Ge, Pb, Bi, Sb, a Si—Y′ alloy (where Y′ is an alkali metal, an alkaline earth metal, a group 13 element, a group 14 element, a transition metal, a rare earth element, or a combination thereof with Y′ not being Si), a Sₙ—Y′ alloy (where Y′ is an alkali metal, an alkaline earth metal, a Group 13 element, a Group 14 element, a transition metal, a rare earth element, or a combination thereof with Y′ not being Sₙ), or the like. The element Y′ may be, for example, Mg, Ca, Sr, Ba, Sc, Y, Ti, Zr, Hf, V, Nb, Ta, Cr, Mo, W, Tc, Re, Fe, Pb, Ru, Os, Rh, Ir, Pd, Pt, Cu, Ag, Au, Zn, Cd, B, Al, Ga, Sn, In, Ti, Ge, P, As, Sb, Bi, S, Se, Te, or a combination thereof. The transition metal oxide may be, for example, a lithium titanium oxide, a vanadium oxide, a lithium vanadium oxide, or the like. The non-transition metal oxide may be, for example, SnO₂, SiOₓ (0<x<2), or the like. The carbon-containing material may be, for example, crystalline carbon, amorphous carbon, or a combination thereof. The crystalline carbon may be, for example, graphite such as natural graphite that may be in an amorphous, plate, flake, spherical, or fibrous form, or artificial graphite. The amorphous carbon may be, for example, soft carbon (carbon calcined at low temperature), hard carbon, meso-phase pitch carbide, calcined coke, or the like. Combinations of two or more of the foregoing materials may be used.

The anode active material layer may further include a conducting material and a binder.

The conducting material and the binder, which may be used in the anode active material layer, may be selected from conducting materials and binders used in the cathode active material layer.

The amount of the binder used in the anode active material layer may be, for example, about 0.1 wt % to about 10 wt % or about 0.1 wt % to about 5 wt % of the total weight of the anode active material layer. The amount of the conducting material used in the anode active material layer may be, for example, about 0.1 wt % to about 10 wt % or about 0.1 wt % to about 5 wt % of the total weight of the anode active material layer. The amount of the anode active material used in the anode active material layer may be, for example, about 80 wt % to about 99 wt %, about 90 wt % to about 99 wt %, or about 95 wt % to about 99 wt % of the total weight of the anode active material layer.

### Interlayer

A unit cell may further include an interlayer disposed between an electrolyte layer and a current collecting member. By the unit cell including the interlayer, generation and/or growth of lithium dendrites between the anode active material layer and the electrolyte layer may be more effectively suppressed. The interlayer may be omitted. The thickness of the interlayer may be smaller than, for example, the thickness of the electrolyte layer.

Alternatively, for example, the interlayer may include: a carbon-containing material, a metal-containing material, or a combination thereof; and a binder. The interlayer may not include an organic electrolyte.

The carbon-containing material and the metal-containing material may be, for example, materials that can be lithiated and delithiated. The carbon-containing material and the metal-containing material included in the interlayer may have, for example, a particle form. The average particle diameter of the carbon-containing material and/or metal-containing material having a particle form may be, for example, about 10 nm to about 4 μm, about 10 nm to about 1 μm, about 10 nm to about 500 nm, about 10 nm to about 100 nm, or about 20 nm to about 80 nm. Without wishing to be bound to theory, since the carbon-containing material and/or the metal-containing material have an average particle diameter within this range, reversible plating and/or dissolution of lithium may be more easily performed during charging and discharging. The average particle diameter of the carbon-based material and/or the metal-based material may be, for example, a median diameter (D50) measured using a laser type particle size distribution analyzer.

The interlayer may include, for example, at least one of a carbon-containing material and a metal-containing material. The carbon-containing material may be, for example, amorphous carbon. The carbon-containing material may be, for example, carbon black (CB), acetylene black (AB), furnace black (FB), Ketjen black (KB), or graphene, but embodiments are not necessarily limited thereto, and any suitable carbon-containing material may be used as long as it is classified as amorphous carbon in the art. The amorphous carbon has no crystallinity or very low crystallinity, and is distinguished from crystalline carbon or graphitic carbon. The metallic material may be a metallic material or a metalloid material. The metallic material may include one or more of gold, platinum, palladium, silicon, silver, aluminum, bismuth, tin, or zinc. For example, since nickel does not form an alloy with lithium, it may not be a metallic material included in the interlayer in this specification. The interlayer may include one of these carbon-containing materials and metal-containing materials, or may include a combination thereof. The interlayer may include, for example, amorphous carbon. The interlayer may include, for example, a mixture of amorphous carbon with one or more of gold, platinum, palladium, silicon, silver, aluminum, bismuth, tin, or zinc. The mixing ratio of the mixture may be, in a weight ratio, for example, about 0:1 to about 1:2, about 10:1 to about 1:1, about 7:1 to about 1:1, about 5:1 to about 1:1, or about 4:1 to about 2:1. The interlayer may include, for example, a combination of first particles made of amorphous carbon and second particles made of a metal or a metalloid. The metal may include, for example, at least one of gold, platinum, palladium, silicon, silver, aluminum, bismuth, tin, zinc, or the like. The amount of the second particles may be about 8% to about 60% by weight, about 10% to about 50% by weight, about 15% to about 40% by weight, or about 20% to about 30% by weight, on the basis of the total weight of the mixture. Without wishing to be bound to theory, by having the amount of the second particles within this range, for example, cycle characteristics of a lithium battery may be further improved.

The binder included in the interlayer may include, for example, styrene-butadiene rubber (SBR), polytetrafluoroethylene, poly(vinylidene fluoride), polyethylene, vinylidene fluoride/hexafluoropropylene copolymers, polyacrylonitrile, or poly(methyl (meth)acrylate), but embodiments are not necessarily limited thereto, and any suitable material may be used including those used as a binder in the art. The binder may be a single binder or may be composed of a plurality of different binders. When the interlayer does not include a binder, the interlayer may be more easily separated from the electrolyte layer 30 or the anode active material layer 23. The amount of the binder included in the interlayer may be, for example, about 1% to about 20 wt % with respect to the total weight of the interlayer.

The thickness of the interlayer may be, for example, about 1 μm to about 20 μm, about 1 μm to about 15 μm, about 2 μm to about 10 μm, or about 3 μm to about 7 μm. The thickness of the interlayer may be, for example, about 1% to about 50%, about 1% to about 30%, about 1% to about 10%, or about 1% to about 5% of the thickness of a cathode active material layer 12. If the thickness of the interlayer is too small, lithium dendrites formed between the interlayer and the anode current collector may collapse the interlayer, making it difficult to improve the cycle characteristics of a solid lithium battery. If the thickness of the interlayer is excessively increased, the energy density of the solid lithium battery may decrease and it may be difficult to improve the cycle characteristics. If the thickness of the interlayer decreases, for example, the charge capacity of the interlayer also decreases. The charge capacity of the interlayer may be, for example, about 0.1% to about 50%, about 1% to about 30%, about 1% to about 10%, about 1% to about 5%, or about 1% to about 2% of the charge capacity of a cathode. If the charge capacity of the interlayer is too small, lithium dendrites formed between the interlayer and the anode current collector may collapse the interlayer, making it difficult to improve the cycle characteristics of the lithium battery. If the charge capacity of the interlayer is excessively increased, the energy density of the lithium battery employing an anode 20 may decrease and it may be difficult to improve cycle characteristics. The charge capacity of the cathode active material layer may be obtained by multiplying the charge capacity density (mAh/g) of the cathode active material by the mass of the cathode active material in the cathode active material layer. When multiple types of cathode active materials are used, the charge capacity density x mass value may be calculated for each cathode active material, and the sum of these values is the charging capacity of the cathode active material layer. The charge capacity of the interlayer may also be calculated in the same way. That is, the charge capacity of the interlayer may be obtained by multiplying the charge capacity density (mAh/g) of the carbon-containing material and/or metal-containing material by the mass of the carbon-containing material and/or metal-containing material in the interlayer. When multiple types of carbon-containing materials and/or metal-containing materials are used, a charge capacity density x mass value may be calculated for each material, and the sum of these values is the capacity of the interlayer. Here, the charge capacity density of the cathode active material and the carbon-containing material and/or the metal-containing material may be the capacity estimated using an all-solid half-cell using metal lithium as a counter electrode. By charge capacity measurement using an all-solid half-cell, the charge capacities of the cathode active material layer and the interlayer may be directly measured. The charge capacity density may be obtained by dividing the measured charge capacity by the mass of each active material. Alternatively, the charge capacities of the cathode active material layer and the interlayer may be initial charge capacities measured at the time of the first cycle charge.

### Lithium Battery

The lithium battery is not particularly limited and may be a lithium primary battery, a lithium secondary battery, a lithium air battery, or the like. The lithium battery may be, for example, a stacked cell. The lithium battery may have, for example, a jelly-roll shape.

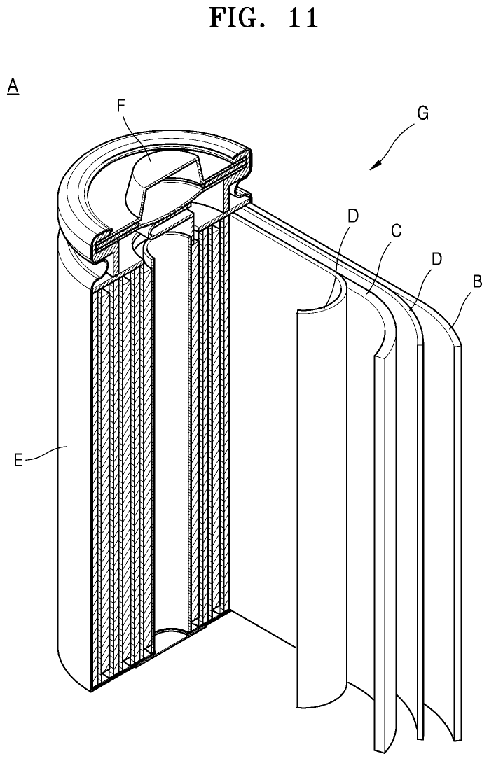

Referring to FIGS. 1 to 9, the lithium battery 100 may be a lithium solid battery including a solid electrolyte. Referring to FIGS. 11 to 13, a lithium battery A may be, for example, a lithium ion battery including a liquid electrolyte impregnating the negative electrode, the positive electrode, and the separator.

Referring to FIG. 11, the lithium battery A according to one or more embodiments includes a cathode C, an anode B, and a separator D. The cathode C, the anode B, and the separator D, may be wound or folded to form a battery structure G. The formed battery structure G is accommodated in a battery case E. An organic electrolyte may be injected into the battery case E and sealed with a cap assembly F to complete the lithium battery A. The battery case E may be cylindrical, but is not necessarily limited to this shape, and may have, for example, a prismatic shape, a thin film shape, or the like.

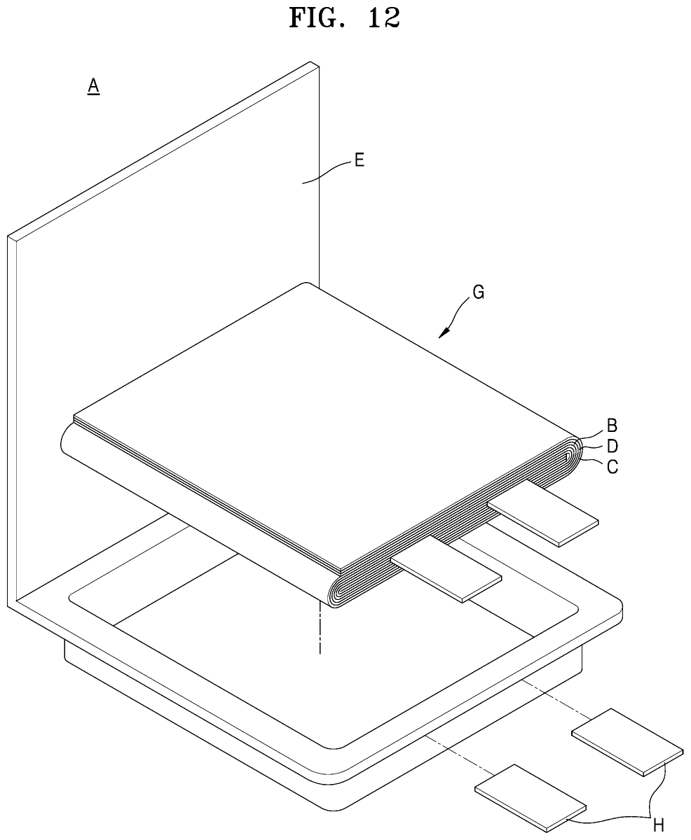

Referring to FIG. 12, the lithium battery A according to one or more embodiments includes a cathode C, an anode B, and a separator D. The separator D may be disposed between the cathode C and the anode B, and the cathode C, the anode B, and the separator D, may be wound or folded to form a battery structure G. The formed battery structure G may be accommodated in the battery case E. An electrode tab H serving as an electrical passage for inducing the current formed in the battery structure G to the outside may be included. An organic electrolyte may be injected into the battery case E and sealed to complete the lithium battery A. The battery case E may be prismatic, but is not necessarily limited to this shape, and may have, for example, a cylindrical shape, a thin film shape, and the like. The lithium battery A may have, for example, a jelly-roll shape.

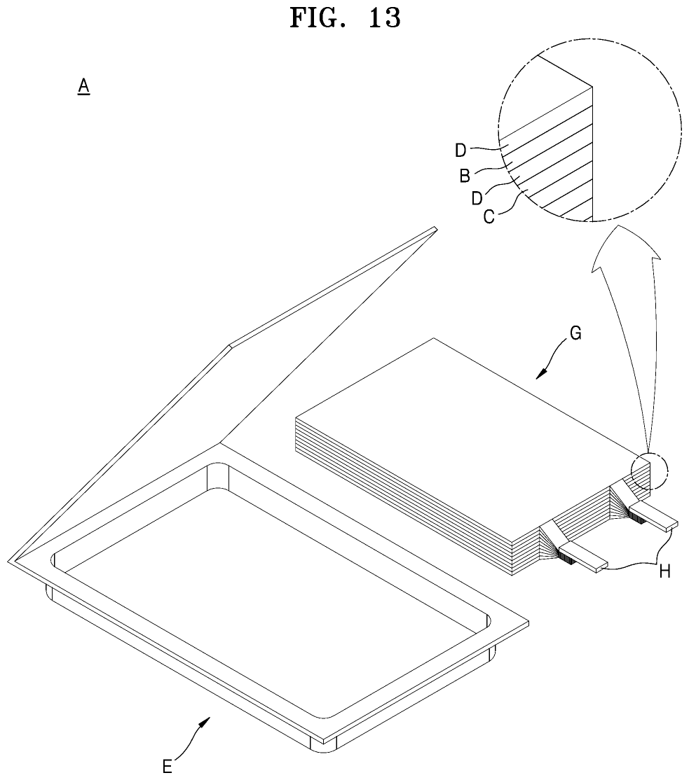

Referring to FIG. 13, a lithium battery A according to one or more embodiments includes a cathode C, an anode B, and a separator D. The separator D may be disposed between the cathode C and the anode B to form a battery structure G. The battery structure G may be stacked in a bi-cell structure and may then be accommodated in a battery case E. An electrode tab H serving as an electrical passage for inducing the current formed in the battery structure G to the outside may be included. An organic electrolyte may be injected into the battery case E and sealed to complete the lithium battery A. The battery case E may be prismatic, but is not necessarily limited to this shape, and may have, for example, a cylindrical shape, a thin film shape, and the like.

Pouch-type lithium batteries correspond to those using a pouch as a battery case in the lithium batteries of FIGS. 11 to 13. A pouch type lithium battery may include one or more battery structures. A battery structure may be formed by placing a separator between a cathode and an anode. The battery structure may be stacked in a bi-cell structure and then impregnated with an organic electrolyte solution, accommodated in a pouch and sealed to complete a pouch-type lithium battery. For example, although not shown, the cathode, the anode, and the separator may be simply stacked and accommodated in a pouch in the form of an electrode assembly, or may be accommodated in a pouch after being rolled or folded into an electrode assembly in the form of a jelly roll. Subsequently, an organic electrolyte solution is injected into the pouch and sealed to complete the lithium battery.

Lithium batteries have excellent lifespan characteristics and high-rate characteristics, and thus may be used, for example, in electric vehicles (EVs). For example, lithium batteries may be used for hybrid vehicles such as plug-in hybrid electric vehicles (PHEVs). In addition, lithium batteries may be used in fields requiring large amounts of power storage. For example, lithium batteries may be used for electric bicycles, electronically driven tools, or the like, but embodiments are not limited thereto.

A plurality of lithium batteries may be stacked to form a battery module, and a plurality of battery modules form a battery pack. These battery packs maybe used in all devices requiring high capacity and high output. For example, battery packs can be used for laptops, smartphones, electric vehicles, or the like. A battery module may include, for example, a plurality of batteries and a frame holding the same. A battery module may include, for example, a plurality of battery modules and a bus bar connecting the same. A battery module and/or a battery pack may further include a cooling device. A plurality of battery packs may be controlled by a battery management system. The battery management system may include a battery pack and a battery controller connected to the battery pack.

### Electrode Current Collecting Member

Referring to FIGS. 6 and 7, an current collecting member 40a according to another embodiment includes a first current collecting layer 42aa, a second current collecting layer 42ab, and a heating layer 44a disposed between the first current collecting layer 42aa and the second current collecting layer 42ab. The first current collecting layer 42aa and the second current collecting layer 42ab may include a metal that does not form an alloy or compound with lithium. The heating layer 44a may include an insulating layer 43a and heating element 41a. The heating layer 44a may include a base film as the insulating layer 43a and heating element 41a, the base film may include a polymer, and the heating element 41a may be electrically separated from the first current collecting layer 42aa and the second current collecting layer 42ab.

Referring to FIGS. 6 and 7, the current collecting member 40a may include a first current collecting layer 42aa, a second current collecting layer 42ab, and a heating layer 44a disposed between the first current collecting layer 42aa and the second current collecting layer 42ab. By the electrode current collecting member including the heating layer 44a, the temperature of the electrode current collecting member increases, and the temperature of the lithium battery including the electrode current collecting member increases, thereby improving cycle characteristics such as high rate characteristics of the lithium battery.

The first current collecting layer 42aa and the second current collecting layer 42ab may include a metal that does not form an alloy or compound with lithium. Since the first current collecting layer 42aa and the second current collecting layer 42ab include a metal that does not form an alloy or compound with lithium, a side reaction with the electrode active material may be suppressed, and thus, the first current collecting layer 42aa and the second current collecting layer 42ab can act as ion insulators. The metal that does not form an alloy or compound with lithium may include, but is not limited to, aluminum, copper, indium, magnesium, titanium, iron, cobalt, nickel, zinc, germanium, an alloy thereof, or a combination thereof, and any suitable material that is used as a current collecting layer material, including those in the art, may be used.

The first current collecting layer 42aa and the second current collecting layer 42ab may have a thickness of, for example, about 1 μm to about 100 μm, about 1 μm to about 50 μm, about 1 μm to about 20 μm, or about 1 μm to about 10 μm.

Without wishing to be bound to theory, since the first current collecting layer 42aa and the second current collecting layer 42ab have a thickness within this range, high-rate charging and discharging can be easily performed.

The first current collecting layer 42aa and the second current collecting layer 42ab may be, for example, a metal foil, a metal sheet, or a metal mesh, but embodiments are not limited thereto.

Alternatively, the first current collecting layer 42aa and the second current collecting layer 42ab may have a thickness of, for example, about 10 nm to about 3 μm, about 50 nm to about 2 μm, about 0.1 μm to about 1 μm, about 0.1 μm to about 0.5 μm, about 0.1 μm nm to about 0.3 μm.

Without wishing to be bound to theory, by the first current collecting layer 42aa and the second current collecting layer 42ab having a thickness in this range, when an overcurrent flows during a short circuit, the overcurrent may be blocked due to cracks. The first current collecting layer 42aa and the second current collecting layer 42ab may act as fuses. By the first current collecting layer 42aa and the second current collecting layer 42ab having a thickness in this range, the stability of the lithium battery may be secured while maintaining conductivity.

The first current collecting layer 42aa and the second current collecting layer 42ab may be disposed on a base film by such a method as plating, deposition, or the like, but embodiments are not limited thereto.

By the first current collecting layer 42aa and the second current collecting layer 42ab having a thickness in this range, the limiting current of the lithium battery is lowered, thereby improving the safety of the lithium battery.

A lead tab may be added on the metal layer for external connection. The lead tab may be welded to the metal layer or the metal layer/base film laminate by ultrasonic welding, laser welding, spot welding, or the like. The metal layer may be electrically connected to the lead tab while the base film and/or the metal layer may be melted during welding. To more securely perform welding between the metal layer and the lead tab, a metal chip may be added between the metal layer and the lead tab. The metal chip may be a flake of the same material as the metal of the metal layer. The metal chip may be, for example, a metal foil or a metal mesh. The metal chip may be, for example, an aluminum foil, a copper foil, or a stainless steel foil, but embodiments are not limited thereto. By welding the metal chip to the lead tab after placing the metal chip on the metal layer, the lead tab may be welded to the metal chip/metal layer laminate or the metal chip/metal layer/base film laminate. While the base film, the metal layer and/or the metal chip are melted during welding, the metal layer or the metal layer/metal chip laminate may be electrically connected to the lead tab. The metal chip and/or the lead tab may be added to a portion of the metal layer.

The heating layer 44a may include an insulating layer 43a and heating element 41a. The heating layer 44a may include a base film as the insulating layer 43a and heating elements 41a. The base film may be an insulator. The base film may include, for example, a polymer. The base film may include, for example, a thermoplastic polymer.

The polymer may include, for example, polyethylene terephthalate, polyethylene, polypropylene, polybutylene terephthalate, polyimide, polyphenylene sulfide, polyamideimide, a liquid crystalline polymer, polyether ether ketone, a polysiloxane, or the like, or a combination thereof. Without wishing to be bound to theory, by the base film including a thermoplastic polymer, an insulating base film melts during a short circuit, and thus, the internal resistance of the lithium battery is increased, thereby suppressing overcurrent.

The thickness of the base film may be, for example, about 1 μm to about 50 μm, about 1.5 μm to about 50 μm, about 1.5 μm to about 40 μm, or about 1 μm to about 30 μm. Without wishing to be bound to theory, by the base film having a thickness within this range, the weight of the lithium battery can be more effectively reduced. The melting point of the base film may be, for example, about 100° C. to about 300° C., about 100° C. to about 250° C., or about 100° C. to about 200° C. Without wishing to be bound to theory by the base film having a melting point within this range, the base film may be melted and easily coupled to the lead tab in the process of welding the lead tab. In order to improve adhesion between the base film and the metal layer, surface treatment such as corona treatment may be performed on the base film. The thickness of the metal chip may be, for example, about 2 μm to about 10 μm, about 2 μm to about 7 μm, or about 4 μm to about 6 μm. Without wishing to be bound to theory, by the metal chip having a thickness within this range, the connection between the metal layer and the lead tab can be more easily performed.

The heating element 41a may be electrically separated from the first current collecting layer 42aa and the second current collecting layer 42ab. By the heating element 41a being electrically separated from the first current collecting layer 42aa and the second current collecting layer 42ab, a short circuit may be prevented. In addition, by the heating element 41a being separated from the first current collecting layer 42aa and the second current collecting layer 42ab, deterioration of the lithium battery due to a local temperature increase on the surface of the electrode current collecting member may be prevented. The heating element 41a may comprise a matrix (e.g., an insulator) and a filler. The heating element 41a may comprise a filler without a matrix (e.g., an insulator).

The device may include the above-described current collecting member. Any suitable device including the above-described electrode current collecting member may include an electrode. The device may be, for example, an electronic electrochemical device. The electrochemical device may include, for example, an electrochemical cell, a supercapacitor, a multilayer ceramic capacitor, or the like. The electrochemical cell may include an alkali metal battery, an alkaline earth metal battery, or the like. The electrochemical cell may include a primary battery, a secondary battery, or the like. The electrochemical cell may include a lithium battery, a fuel cell, a solar cell, a color changing device, or the like. The lithium battery may include a lithium ion battery, a lithium sulfur battery, a lithium solid battery, a lithium air battery, or the like.

The present subject matter is described in further detail through the following Examples and Comparative Examples. However, the following examples are provided for illustrating purposes and the scope of the embodiments should not be limited only thereto.

### EXAMPLES

### Manufacture of Lithium Battery

### Example 1: Bi-Cell Battery and Anode Current Collecting Member Having Heating Element

### Manufacture of Current Collecting Member

A heating film was disposed between two current collecting layers, each made of a copper film, to prepare a current collecting member. The current collecting member had a first current collecting layer/heating layer/second current collecting layer laminate structure.

The thickness of each of the two current collecting layers was 10 μm. The heating film had a structure in which a planar heating element was embedded in an insulating resin film. The thickness of the heating film corresponding to the heating layer was 100 μm. The current collecting member corresponds to an anode current collector.

### Manufacture of Cathode Layer

LiNi_{0.8}Co_{0.1}Al_{0.1}O₂ (NCA) as a cathode active material, poly(vinylidene fluoride) as a binder, and carbon black as a conducting agent were prepared. Then, these materials were mixed with the NMP solvent in a mass ratio of cathode active material:conducting agent:binder of 97:1:2. The mixture was coated on a 10 μm thick aluminum-foil cathode current collector to prepare a cathode layer.

The cathode active material layer of the manufactured cathode layer was impregnated with an electrolyte solution in which 2.0 molar (M) lithium bis(fluorosulfonyl)imide (LiFSI) was dissolved in Pyr13FSI (N-propyl-N-methyl-pyrrolidinium bis(fluorosulfonyl)imide) as an ionic liquid.

### Manufacture of Anode Active Material Layer/Solid Electrolyte Layer/Cathode Layer Laminate

Li_{6.5}La₃Zr_{1.5}Ta_{0.5}O₁₂ pellets (hereinafter referred to as LLZO pellets) having a diameter of 14 millimeters (mm) and a thickness of 500 μm were prepared as a solid electrolyte layer. As the LLZO pellets, LLZO pellets were treated with 1 M hydrochloric acid for 40 minutes, and then vacuum dried.

A 20 μm thick lithium foil was placed on one side of the solid electrolyte layer, and a lithium metal layer was attached to the LLZO by applying 250 megapascals (MPa) of pressure at 25° C. by cold isotactic pressing (CIP). The lithium metal layer was an anode active material layer.

An anode active material layer/solid electrolyte layer/cathode layer laminate was prepared by placing the cathode layer on the other surface of the solid electrolyte layer so that the cathode active material layer was in contact with the solid electrolyte layer. The laminate was a unit cell. A second unit cell was then prepared in a similar manner.

### Manufacture of Lithium Battery

The first unit cell and the second unit cell were disposed such that anode active materials thereof face each other, and the current collecting member was disposed between the anode active material layers facing each other, followed by sealing, thereby manufacturing a lithium battery.

### Example 2: Bi-Cell Battery and Cathode Current Collecting Member Having Heating Element

### Manufacture of Current Collecting Member

A heating film was disposed between two current collecting layers made of aluminum (Al) thin films to prepare a current collecting member. The current collecting member had a first current collecting layer/heating layer/second current collecting layer laminate structure.

The thickness of each of the two current collecting layers was 10 μm. The heating film had a structure in which a planar heating element was embedded in an insulating resin film. The thickness of the heating film corresponding to the heating layer was 100 μm. The current collecting member corresponds to a cathode current collector.

### Manufacture of Solid Electrolyte Layer/Anode Layer Laminate

Li_{6.5}La₃Zr_{1.5}Ta_{0.5}O₁₂ pellets (hereinafter referred to as LLZO pellets) having a diameter of 14 mm and a thickness of 500 μm were prepared as a solid electrolyte layer. As the LLZO pellets, LLZO pellets were treated with 1 M hydrochloric acid for 40 minutes and vacuum dried.

A 20 μm thick lithium foil was placed on one side of the solid electrolyte layer, and a lithium metal layer was attached to the LLZO by applying 250 MPa at 25° C. by CIP. The lithium metal layer is an anode active material layer.

The anode current collector made of a 10 μm thick copper film was disposed on the lithium metal layer, and the anode current collector was attached by applying 250 MPa at 25° C. by CIP, thereby preparing a solid electrolyte layer/anode layer laminate.

### Manufacture of Cathode Active Material Layer/Solid Electrolyte Layer/Anode Layer Laminate

LiNi_{0.8}Co_{0.1}Al_{0.1}O₂ (NCA) as a cathode active material, poly(vinylidene fluoride) as a binder, and carbon black as a conducting agent were prepared. Then, these materials were mixed with the NMP solvent in a mass ratio of cathode active material:conducting agent:binder of 97:1:2. The mixture was coated on the solid electrolyte layer of the solid electrolyte layer/anode layer laminate to manufacture a cathode active material layer/solid electrolyte layer/anode layer laminate. The laminate was a unit cell. A second unit cell was prepared in a similar manner.

The cathode active material layer was impregnated with an ionic liquid electrolyte by dropping, on the manufactured cathode active material layer, an electrolyte solution in which 2.0 M LiFSI was dissolved in Pyr13FSI (N-propyl-N-methyl-pyrrolidinium bis(fluorosulfonyl)imide) as an ionic liquid.

### Manufacture of Lithium Battery

The first unit cell and the second unit cell were disposed such that cathode active materials thereof face each other, and the current collecting member was disposed between the cathode active material layers facing each other, followed by sealing, thereby manufacturing a lithium battery.

### Example 3: Bi-Cell Battery and Bi-Polar Current Collecting Member Having Heating Element

### Manufacture of Current Collecting Member

A heating film (heating layer) was disposed between two current collecting layers made of copper films to prepare current collecting member. The current collecting member had a first current collecting layer/heating layer/second current collecting layer laminate structure.

The thickness of each of the two current collecting layers was 10 μm. The heating film had a structure in which a planar heating element was embedded in an insulating resin film. The thickness of the heating film corresponding to the heating layer was 100 μm.

### Manufacture of Solid Electrolyte Layer/Anode Layer Laminate

Li_{6.5}La₃Zr_{1.5}Ta_{0.5}O₁₂ pellets (hereinafter referred to as LLZO pellets) having a diameter of 14 mm and a thickness of 500 μm were prepared as a solid electrolyte layer. As the LLZO pellets, LLZO pellets were treated with 1 M hydrochloric acid for 40 minutes and vacuum dried.

A 20 μm thick lithium foil was placed on one side of the solid electrolyte layer, and a lithium metal layer was attached to the LLZO by applying 250 MPa at 25° C. by CIP. The lithium metal layer was an anode active material layer.

### Manufacture of Cathode Active Material Layer/Solid Electrolyte Layer/Anode Layer Laminate

LiNi_{0.8}Co_{0.1}Al_{0.1}O₂ (NCA) as a cathode active material, poly(vinylidene fluoride) as a binder, and carbon black as a conducting agent were prepared. Then, these materials were mixed with the NMP solvent in a mass ratio of cathode active material:conducting agent:binder of 97:1:2. The mixture was coated on the solid electrolyte layer of the solid electrolyte layer/anode layer laminate to manufacture a cathode active material layer/solid electrolyte layer/anode layer laminate. The laminate was a unit cell. Then, a second unit cell was prepared in a similar manner.

The cathode active material layer was impregnated with an ionic liquid electrolyte by dropping, on the manufactured cathode active material layer, an electrolyte solution in which 2.0 M LiFSI was dissolved in Pyr13FSI (N-propyl-N-methyl-pyrrolidinium bis(fluorosulfonyl)imide) as an ionic liquid.

### Manufacture of Lithium Battery

The first unit cell and the second unit cell were disposed such that cathode active materials thereof face each other, and the current collecting member was disposed between the cathode active material layers facing each other, followed by sealing, thereby manufacturing a lithium battery.

The current collecting member was disposed between the facing unit cells such that the first current collecting layer of the current collecting member was in contact with the anode active material layer of the first unit cell and the second current collecting layer of the current collecting member was in contact with the cathode active material layer of the second unit cell.

### Comparative Example 1: Bi-Cell Battery and Heating Element-Free Anode Current Collecting Member

A lithium battery was manufactured in the same manner as in Example 1, except that a film having the same thickness that did not include a planar heating element was used in manufacturing the current collecting member. The thickness of the film without the planar heating element was 100 μm.

### Comparative Example 2

A lithium battery was manufactured in the same manner as in Example 1, except that a 10 μm thick copper foil was disposed between the first unit cell and the second unit cell, as an anode collector, instead of the current collecting member, and the current collecting member as in Example 1 was disposed on the outermost layer of the first unit cell, instead of an aluminum foil.

### Evaluation Example 1: Interfacial Resistance Evaluation

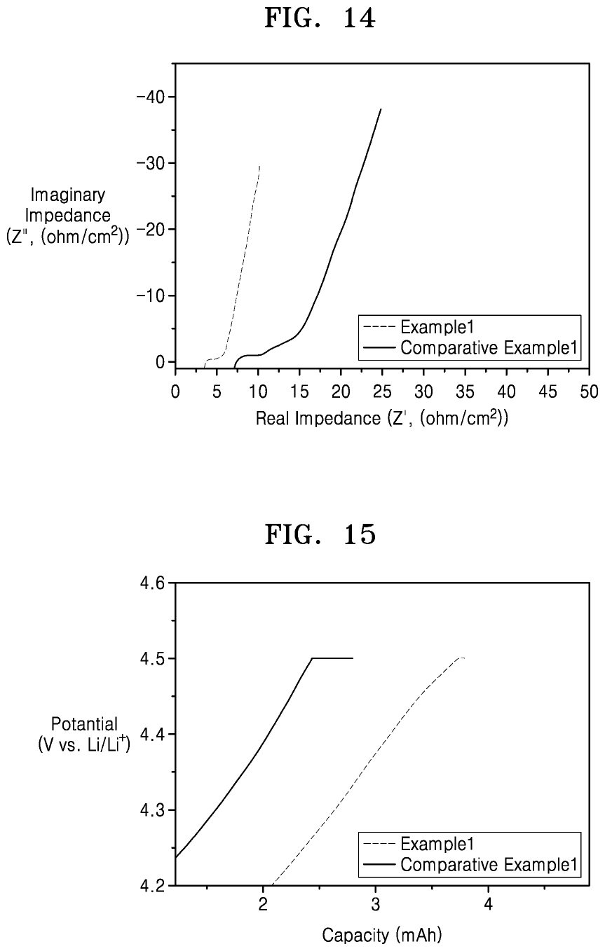

For the lithium batteries prepared in Examples 1 to/3 and Comparative Example 1, the interfacial resistances were measured, and some of the results are shown in FIG. 14.

When interfacial resistances were measured, the temperature of the heating element of the lithium battery of Example 1 was about 100° C., and the temperature of the lithium battery of Comparative Example 1 was about 25° C.

Interfacial resistance was obtained by measuring the impedance of the lithium battery by a 2-probe method using an impedance analyzer (Solartron 1400A/1455A impedance analyzer). The frequency range was 0.1 hertz (Hz) to 1 megahertz (MHz), and the amplitude voltage was 10 millivolts (mV). The measurement was performed at 25° C. in an air atmosphere. Nyquist plots of the impedance measurement results for the all-solid-state secondary batteries of Example 1 and Comparative Example 1 are shown in FIG. 14, respectively.

As shown in FIG. 14, the interface resistance of the lithium battery of Example 1 was reduced by 50% or more, compared to the lithium battery of Comparative Example 1.

Accordingly, it was confirmed that the internal resistance of the lithium battery of Example 1 was reduced by 50% or more, compared to the lithium battery of Comparative Example 1.

### Evaluation Example 2: Energy Density Evaluation

For the lithium batteries prepared in Examples 1 to 3 and Comparative Example 1, charge/discharge tests were conducted under the following conditions, and some of the measurement results are shown in FIG. 15.

The lithium batteries prepared in Example 1 and Comparative Example 1 were charged with a current of 0.5 milliamperes per square centimeter (mA/cm²) until the potential reached 4.5 V (vs. Li/Li⁺), and discharged with a constant current of 0.5 mA/cm² until the potential reached 2.75 V (vs. Li/Li⁺).

When interfacial resistance was measured, the temperature of the heating element of the lithium battery of Example 1 was about 100° C., and the temperature of the lithium battery of Comparative Example 1 was about 25° C.

Some of the charging profiles of the lithium batteries prepared in Example 1 and Comparative Example 1 are shown in FIG. 15.

As shown in FIG. 15, the charging capacity of the lithium battery of Example 1 increased by 20% or greater when reaching 4.5 V, compared to the lithium battery of Comparative Example 2.

Therefore, it was confirmed that the energy density of the lithium battery of Example 1 was increased compared to the energy density of the lithium battery of Comparative Example 1. In addition, the lithium battery of Example 1 can prevent overvoltage during charging.

### Evaluation Example 3: Evaluation of High-Rate Characteristics

For the lithium batteries prepared in Examples 1 to 3 and Comparative Examples 1 to 2, charge/discharge tests were performed under the following conditions.

When the high-rate characteristics were evaluated, the temperature of the heating element of the lithium battery of Example 1 was about 100° C., and the temperature of the lithium battery of Comparative Example 1 was about 25° C.

In the first cycle, the lithium batteries were charged with a constant current of 0.1 C until the potential reached 4.3 V (vs. Li/Li⁺), and discharged with a constant current of 0.1 C until the potential reached 2.75 V (vs. Li/Li⁺).

In the second cycle, the lithium batteries were charged with a constant current of 0.2 C until the potential reached 4.3 V (vs. Li/Li⁺), and discharged with a constant current of 0.2 C until the potential reached 2.75 V (vs. Li/Li⁺).

In the third cycle, the lithium batteries were charged with a constant current of 0.3 C until the potential reached 4.3 V (vs. Li/Li⁺), and discharged with a constant current of 0.3 C until the potential reached 2.75 V (vs. Li/Li⁺).

In the second cycle, the lithium batteries were charged with a constant current of 0.5 C until the potential reached 4.3 V (vs. Li/Li⁺), and discharged with a constant current of 0.5 C until the potential reached 2.75 V (vs. Li/Li⁺).

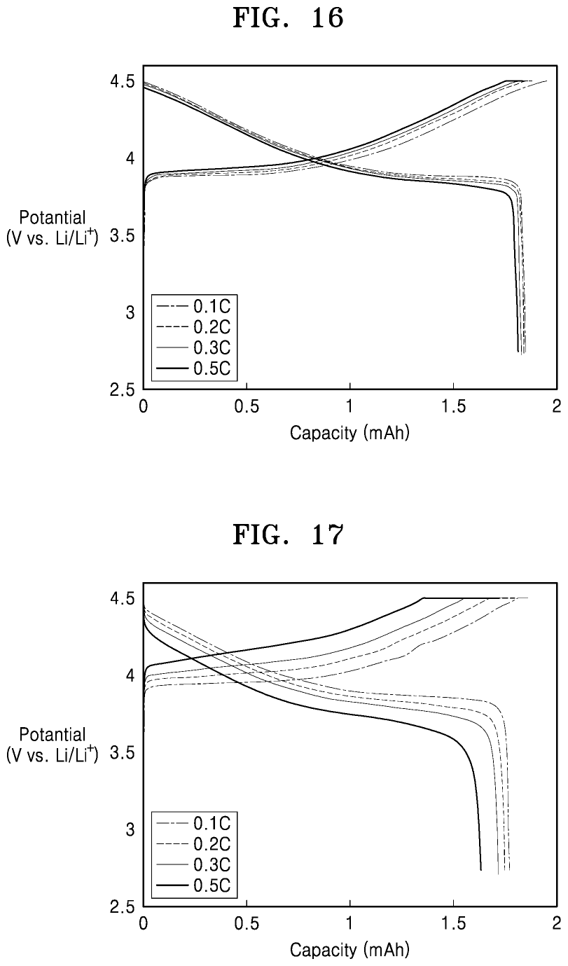

In all charge/discharge cycles, a halt time of 10 minutes was given after one charge/discharge cycle. Some of the room temperature charge/discharge test results are shown in FIGS. 16 to 18.

As shown in FIG. 16, the lithium battery of Example 1 showed a slight decrease in discharge capacity even during high-rate charging and discharging cycles. As shown in FIG. 17, the lithium battery of Comparative Example 1 showed a significant decrease in discharge capacity during high-rate charging and discharging cycles. Therefore, the lithium battery of Example 1 had improved high-rate characteristics compared to the lithium battery of Comparative Example 1.

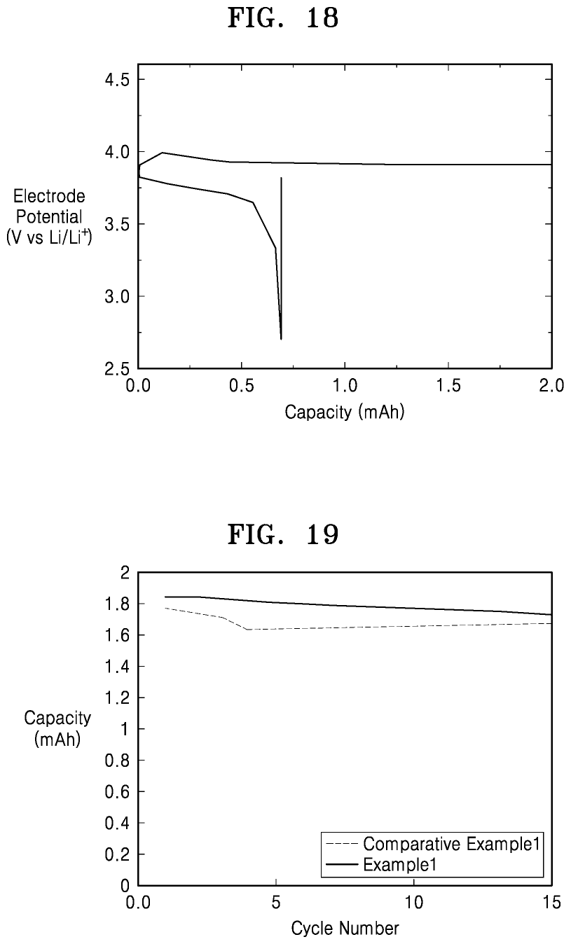

As shown in FIG. 18, a short circuit occurred to the lithium battery of Comparative Example 2 during charging and discharging. In the lithium battery of Comparative Example 2, a short circuit occurred due to deterioration due to temperature non-uniformity caused by a local temperature increase inside the lithium battery.

### Evaluation Example 3: Evaluation of Charge/Discharge Characteristics

For the lithium batteries prepared in Example 1 and Comparative Example 1, charge/discharge tests were performed under the following conditions.

When the charge/discharge characteristics were evaluated, the temperature of the heating element of the lithium battery of Example 1 was about 100° C., and the temperature of the lithium battery of Comparative Example 1 was about 25° C.

The lithium batteries were charged with a constant current of 0.5 C until the potential reached 4.3 V (vs. Li/Li⁺), and discharged with a constant current of 0.5 C until the potential reached 2.75 V (vs. Li/Li⁺). This cycle was repeated 15 times.

The charge/discharge test results are shown in FIG. 19.

As shown in FIG. 19, the discharge capacity of the lithium battery of Example 1 was improved as a whole, compared to the lithium battery of Comparative Example 1. The average discharge capacity of the lithium battery of Example 1 was 3.2 mAh/cm², which was about 10% greater than the average discharge capacity of the lithium battery of Comparative Example 1, which was only 2.9 mAh/cm².

According to an aspect, by including a current collecting member having a heating element disposed therein, degradation in the capacity of a lithium battery may be suppressed and high-rate characteristics are improved.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments. While one or more exemplary embodiments have been described with reference to the figures, it will be understood by those of ordinary skill in the art that various changes in form and details may be made therein without departing from the spirit and scope as defined by the following claims.

What is claimed is:

1. A lithium battery, comprising:
a plurality of unit cells; and
one or more current collecting members,
wherein each of the plurality of unit cells comprises a first electrode active material layer, a second electrode active material layer, and an electrolyte layer disposed between the first electrode active material layer and the second electrode active material layer,
the one or more current collecting members comprises a first current collecting member disposed between a first unit cell and a second unit cell of the plurality of unit cells, wherein the first unit cell and the second unit cell are adjacent to each other,
the first current collecting member comprises:
a first surface in contact with the first unit cell,
a second surface opposite the first surface and in contact with the second unit cell,
a first current collector, and
a heating element disposed between the first surface and the second surface,
wherein the heating element is spaced apart from the first unit cell and the second unit cell.

2. The lithium battery of claim 1, wherein
the heating element is embedded in the first current collector, or
the heating element is sandwiched between a plurality of current collecting layers comprised in the first current collector.

3. The lithium battery of claim 1, wherein
a thickness of the heating element is about 1% to about 90% of a total thickness of the first current collecting member,
the thickness of the heating element is about 0.1 micrometers to about 500 micrometers,
a volume of the heating element is about 1% to about 90% of a total volume of the first current collecting member, and
an area of the heating element is about 1% to about 100% of a total area of the first current collecting member,
wherein the area of the heating element is an area occupied by the heating element in a cross section of the first current collecting member including the heating element, obtained by cutting parallel to the first surface and between the first surface and the second surface of the first current collecting member.

4. The lithium battery of claim 1, wherein
the heating element comprises a matrix and a filler, and
the filler is embedded in the matrix.

5. The lithium battery of claim 4, wherein
the filler comprises a nanostructure, and
the filler is a one-dimensional nanostructure, a two-dimensional nanostructure, a three-dimensional nanostructure, or a combination thereof.

6. The lithium battery of claim 4, wherein the filler comprises a metal, a carbon-containing material, an oxide, a boride, a carbide, a chalcogenide, or a combination thereof.

7. The lithium battery of claim 4, wherein
the matrix comprises an insulator, wherein the matrix comprises a glass frit, a polymer, or a combination thereof,
the glass frit comprises a silicon oxide, a lithium oxide, a nickel oxide, a cobalt oxide, a boron oxide, a potassium oxide, an aluminum oxide, a titanium oxide, a manganese oxide, a copper oxide, a zirconium oxide, a phosphorus oxide, a zinc oxide, a bismuth oxide, a lead oxide, a sodium oxide, or a combination thereof, and
the glass frit further comprises an additive comprising Li, Ni, Co, B, K, Al, Ti, Mn, Cu, Zr, P, Zn, Bi, Pb, Na, or a combination thereof, and
the polymer comprises a thermoplastic polymer, wherein the polymer comprises polyethylene terephthalate, polyethylene, polypropylene, polybutylene terephthalate, polyimide, polyphenylene sulfide, polyamideimide, a liquid crystalline polymer, polyether ether ketone, a polysiloxane, or a combination thereof.

8. The lithium battery of claim 1, wherein
the heating element comprises a one-dimensional heating element, a two-dimensional heating element, a three-dimensional heating element, or a combination thereof.

9. The lithium battery of claim 1, wherein
the heating element has a patterned array,
the heating element comprises a patterned two-dimensional heating element, a patterned three-dimensional heating element, or a combination thereof.

10. The lithium battery of claim 1, wherein
the first current collecting member comprises a first current collecting layer comprising the first surface, a second current collecting layer comprising the second surface, and a heating layer disposed between the first current collecting layer and the second current collecting layer,
the heating layer comprises the heating element, wherein the heating element is electrically separated from the first current collecting layer and the second current collecting layer,
the heating layer further comprises an insulating layer, wherein the insulating layer is disposed between the heating element and the first current collecting layer and between the heating element and the second current collecting layer.

11. The lithium battery of claim 10, wherein
at least one of the first current collecting layer and the second current collecting layer comprises a metal, and
the metal comprises copper, nickel, aluminum, indium, magnesium, titanium, iron, cobalt, zinc, germanium, stainless steel, lithium, an alloy thereof, or a combination thereof.

12. The lithium battery of claim 10, wherein
the heating layer has a thickness of about 0.1 micrometers to about 500 micrometers, and
each of the first current collecting layer and the second current collecting layer has a thickness of about 10 nanometers to about 100 micrometers.

13. The lithium battery of claim 10, wherein
the first current collecting member is a flexible film, and the first current collecting member is a self-standing film,
a total density of the first current collecting member is less than a density of metal included in the first current collecting layer or the second current collecting layer,
and the total density of the first current collecting member is about 95% or less than the density of the metal.

14. The lithium battery of claim 1, wherein
the first surface of the first current collecting member is in contact with the first electrode active material layer of the first unit cell, and
the second surface of the first current collecting member is in contact with the first electrode active material layer of the second unit cell.

15. The lithium battery of claim 14, wherein
the first electrode active material layer is an anode active material layer,
the first current collecting member is an anode current collecting member, and
the first current collecting member comprises copper, nickel, indium, magnesium, titanium, iron, cobalt, zinc, germanium, stainless steel, an alloy thereof, or a combination thereof.

16. The lithium battery of claim 14, wherein
the first electrode active material layer is a cathode active material layer,
the first current collecting member is a cathode current collecting member, and
the first current collecting member comprises aluminum, indium, magnesium, titanium, iron, cobalt, zinc, germanium, stainless steel, an alloy thereof, or a combination thereof.

17. The lithium battery of claim 1, wherein
the first surface of the first current collecting member is in contact with the second electrode active material layer of the first unit cell, and
the second surface of the first current collecting member is in contact with the first electrode active material layer of the second unit cell.

18. The lithium battery of claim 17, wherein
the first electrode active material layer of the second unit cell is a cathode active material layer, and the second electrode active material layer of the first unit cell is an anode active material layer, or
the first electrode active material layer of the first unit cell is an anode active material layer, and the second electrode active material layer of the second unit cell is a cathode active material layer.

19. The lithium battery of claim 1, comprising:
the plurality of unit cells stacked in a thickness direction of the lithium battery; and
the one or more current collecting members further comprises a plurality of current collecting members disposed between the plurality of unit cells,
wherein each of the plurality of current collecting members comprises a heating element, or wherein among the plurality of current collecting members, a proportion of the plurality current collecting members comprising the heating element is about 50% or less, and
the current collecting members that comprise the heating element are disposed at regular intervals along the thickness direction of the lithium battery.

20. The lithium battery of claim 1, wherein, at atmospheric pressure and ambient room temperature, a temperature of the current collecting member during charging and discharging cycles of the lithium battery is about 40° C. to about 100° C., and
at atmospheric pressure and ambient room temperature, a charging time to about 80% of the state of charge of the lithium battery is about 20 minutes or less.

21. The lithium battery of claim 1, wherein
the electrolyte layer comprises a solid electrolyte, a liquid electrolyte, or a combination thereof, and
the anode active material layer comprises lithium metal or a lithium alloy.
